(19) United States
(12) Patent Application Publication
(10) Pub. No.: US 2006/0173759 A1
(43) Pub. Date: Aug. 3, 2006

(54) System and method for two-pass regulatory compliance

(76) Inventors: Timothy T. Green, Ladera Ranch, CA (US); Lynette I. Hotchkiss, Lake Forest, CA (US); Jason Connolly, Irvine, CA (US); Albert V. Ogrodski JR., Anaheim, CA (US); Louis Pizante, Los Angeles, CA (US); Paul Nidenberg, Brooklyn, NY (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 10/971,425

(22) Filed: Oct. 22, 2004

(51) Int. Cl. G06Q 40/00

(52) U.S. Cl. 705/35

(57) ABSTRACT

An automated system and method for ensuring that information in the form of data files provided by highly regulated businesses, such as financial institutions, comply with the most currently applicable Federal, state and local laws and regulations. This may be accomplished by applying a set of computer-encoded compliance rules to the transaction data files from these businesses in a two-pass regulatory compliance review methodology. In a first pass, a limited set of input data elements from one or more input transaction data files is used that results in an extremum or worst-case condition for compliance assessment by using one or more compliance rule sets. The transaction data files that are found to be not in compliance when using this limited set of data elements may or may not be in compliance when using a more complete and detailed set of data elements in a second pass.

### BACKGROUND OF INVENTION

The present invention relates generally to systems and methods for ensuring that information in the form of data files provided by businesses in highly regulated industries, such as financial institutions, comply with the most currently applicable Federal, state and local laws and regulations. This may be accomplished by applying a set of computer-encoded compliance rules to the information obtained from these businesses concerning regulated transactions. More particularly, the invention is a system and method for using batch and direct real-time delivery of provided transaction data files for compliance review, and for applying two-pass regulatory compliance review methodology to these provided transaction data files. In a first pass, a limited set of input data elements from one or more input transaction data files is used that results in an extremum or worst-case condition for compliance assessment of the one or more input transaction data files by using one or more compliance rule sets. The transaction data files that are found to be in compliance using this limited set of data elements are ensured to be in compliance even if a more complete and detailed set of input data elements had been used. The transaction data files that are found to be not in compliance when using this limited set of data elements may or may not be in compliance when using a more complete and detailed set of data elements. In a second pass, the reduced number of transaction data files that were found to be not in compliance when using a limited set of data elements are resubmitted for another compliance assessment using a more complete and detailed set of input data elements. By resubmitting the transaction data files that were found to not be in compliance with the one or more compliance rule sets in the first pass, the more complete and detailed set of input data elements supplied in the second pass enables more accurate identification of transaction data files that are not in compliance with the one or more compliance rule sets. The second pass identifies the subset of transaction data files in the non-compliant first pass group that are actually in compliance by using the more complete and detailed set of input data elements to conduct a more accurate assessment of compliance. The second pass also identifies the subset of transaction data files in the non-compliant first pass group that are truly non-compliant by using the more complete and detailed set of input data elements to conduct a more accurate assessment of compliance using the selected one or more compliance rule sets. This methodology enables compliance assessment where limited financial transaction data is available. It also provides cost allocation between financial transactions that are found to be in compliance after a first pass using a limited data set and those financial transactions that require a more labor-intensive second pass compliance assessment using detailed data.

Regulatory compliance requirements are prevalent in many industry sectors. Most of these regulations have been promulgated for protection of consumers. To protect consumers involved in these transactions, the Federal government as well as state and local governments has enacted laws and regulations that impose requirements on institutions and personnel involved in these businesses. These laws and regulations establish transactional standards and disclosure requirements that are enforced by Federal, state, and local agencies. As new laws, regulations, licenses, and rules are added over time, business transactions have become more varied, complex and prone to error, resulting in an increase in exposure to non-compliance liabilities for the businesses that are engaged in these regulated activities. For example, with the growing complexity of the financial services industry, consumers are frequently subjected to compliance errors, overcharges, and careless practices in processing loans.

Federal, state, and local regulators are conducting increasingly aggressive policing campaigns to ensure compliance by the financial services industry. These efforts have significantly increased the costs for non-compliance in terms of monetary penalties and legal expenses, as well as in terms of tarnished reputations to the financial institutions. Because of the substantial growth in Internet and multi-state activities, the potential for serious compliance violations is likely to increase along with a corresponding increase in compliance scrutiny and enforcement activities by Federal, state, and local regulatory agencies. The financial services industry faces the prospect of significant losses if they are forced to refund fees and charges, void noncompliant transactions, and pay civil and criminal penalties. To counter these potential losses, the industry will incur increased expenses associated with compliance audits and compliance policies, procedures and reporting.

In order to overcome these problems and to satisfy regulatory compliance requirements, institutions offering financial services to consumers have attempted to audit transaction compliance on a manual basis. This approach results in a tedious, time-consuming and costly process that allows only a small statistical sample of transaction applications to be examined for compliance with regulatory requirements. The results of this process are also oftentimes inconsistent due to factors such as varying degrees of understanding, differences in interpretation of the laws and regulations and human processing errors. As competition increases, there is a strong need to reduce the cost of adherence to regulatory compliance standards as well as to reduce penalties for failure to meet compliance requirements. For example, some mortgage companies have attempted to employ risk management techniques, which have proved inadequate as a solution to compliance and related liability problems. While the home mortgage loan industry is probably more regulated than other industries, the compliance difficulties are also encountered in many other areas. Other applications where automated compliance assessment would reduce costs and speed transaction processing include automobile and other consumer loans, leasing transactions, as well as regulatory requirements for other industries, including but not limited to the healthcare and environmental-related industries.

The financial services industry includes a primary segment that initiates financial transactions resulting in financial instruments and a secondary segment that purchases groups or portfolios of financial instruments originated in the primary segment. In the home mortgage industry, for example, primary lenders are those making mortgage loans directly to borrowers, such as savings and loan associations, commercial banks, and mortgage companies. These primary lenders are responsible for assuring regulatory compliance of all loans that they originate, and oftentimes sell packages or portfolios of their mortgage loans into the secondary mortgage market to investors such as pension funds, life insurance companies, or institutions such as Fannie Mae, Freddie Mac or Ginny Mae. The secondary market serves to balance mortgage credit between different regions of the country. In order to sustain a liquid secondary mortgage market, mortgage contracts must meet industry standards, be supported by underwriting guidelines, and comply with all applicable Federal, state and local laws and regulations. Investors require information about these mortgage instruments in order to compare with alternative investments. One of the key factors considered by investors prior to purchasing a portfolio of closed mortgage loans is whether the mortgage loans in a given portfolio comply with all required jurisdictional regulatory compliance requirements. This is important since the primary market institutions that originate the mortgage loans are responsible for compliance assessment. The secondary market investors do not control regulatory compliance of the mortgage loans but-may be at risk for regulatory compliance errors of the loan originators, as purchasers of the portfolio of closed loans. To further complicate the investments decisions, there is often only a limited subset of loan and fee data available to purchasers of a portfolio of mortgage loans, and there are significant costs associated with manually obtaining the required information.

In response to the increased regulatory burden, financial institutions in the primary market are increasingly relying on automated computer-based methods for ensuring regulatory compliance of their transaction data files in their data repositories. For an example of compliance delivery in the mortgage loan industry, there exists the capability of seamlessly extracting mortgage data files from a loan origination system of a primary market institution, determining if the loan data file is in compliance with all Federal, state and local laws and regulations, and notifying a user of the results of the regulatory compliance assessment. There is a requirement for batch compliance delivery where primary and secondary market participants can submit spreadsheets or flat files for regulatory compliance review, and users are notified when compliance assessment results are available via reporting means. There is also a requirement for direct compliance delivery where primary and secondary market participants that do not have all data available in electronic format can provide input, modification and submission of transaction file data, either individually or as a group, for compliance review. There is also a need for quickly determining compliance of a group of transaction data files with a selected compliance rule set where there is limited data available concerning the transaction data files. This latter need is particularly useful for determining regulatory compliance of a portfolio of financial instruments by a potential secondary market purchaser who lacks direct proximity to a loan origination process.

### SUMMARY OF THE INVENTION

The present invention provides a system and method for selecting, creating, modifying and controlling batch delivery of compliance data to be reviewed, where primary and secondary market participants submit spreadsheets or flat files for compliance review via a browser-based direct user interface. The browser-based direct user interface also enables keyboard delivery of compliance review data where primary and secondary market participants that do not have all data available in electronic format can provide input, modification and submission of transaction data files, either individually or as a group, for compliance review. In addition, the browser-based direct user interface provides for quickly determining compliance of a group of transaction data files with a selected compliance rule set where there is limited data available. This capability of the browser-based user interface relies on a novel two-pass regulatory compliance review methodology.

The present invention relies on comparisons of transaction data files with sets of computer-encoded compliance rules to provide compliance assurance for the consumer, the financial services industry, Federal, state, and local regulatory agencies, and the investment community. The computer-encoded compliance rules are used by a regulatory compliance system to verify that all compliance review data for every transaction adheres to the most current Federal, state and local requirements. For example, requirements for the mortgage lending industry include the following:
Truth-In-Lending Act (TIL) Requirements
Real Estate Settlement Procedures Act (RESPA)
Home Mortgage Disclosure Act (HMDA)
Office of Foreign Asset Control (OFAC)
Home Ownership and Equity Protection Act (HOEPA)
Lender and Broker Licensing Requirements
State Regulatory Laws Regulating Financial Transactions
State and Local High Cost Calculations Requirements
Predatory Lending Rules and Regulations
Flood Zone Determination

Using the mortgage lending industry as an example, the computer-encoded compliance rules are used by a regulatory compliance system to ensure that the data is free of calculation errors, interest/usury rate violations, finance charge restrictions, and prohibited practices. These include, but are not limited to, high cost loan restrictions, loan term and amortization restrictions, restricted/prohibited charges and fees, late charge limitations, and prepayment penalty limitations that may lead to violations of applicable Federal, state and local requirements. As a result of the computer-encoded compliance rules, any areas of noncompliance are identified as exceptions and presented to the processing agent by the regulatory compliance system for corrective action. A regulatory compliance rules generation process that may be used in the present invention is disclosed in U.S. patent application Ser. No. 10/710,866 entitled SYSTEM AND METHOD FOR REGULATORY RULES REPOSITORY GENERATION AND MAINTENANCE, filed on Aug. 9, 2004, which is incorporated herein by reference. A regulatory compliance assessment system that may be used with the present invention is disclosed in U.S. patent application Ser. No. 10/249,784 entitled SYSTEM AND METHOD FOR AUTOMATED LOAN COMPLIANCE ASSESSMENT, filed on May 7, 2003, which is incorporated herein by reference.

Automated regulatory compliance assessment may be provided, for example, to lending residential mortgage originators in the primary market and to investors in the secondary market. Regulatory compliance determination is accomplished by applying a set of computer-encoded compliance rules to data files for each financial transaction by a regulatory compliance assessment system. Compliance assessment by the regulatory compliance assessment system may be provided through a batch file upload process to the compliance assessment system, or via real-time integration with a financial institution's loan origination system or a purchaser's underwriting system for data extraction and upload to the compliance assessment system. The present invention provides a browser-based direct user interface to the regulatory compliance assessment system for market participants who may not have available electronically formatted data required for batch file upload or real-time data extraction. The direct user interface is particularly suited for post-closing quality assurance, servicing and loan level due diligence investigation.

The browser-based direct user interface allows users to upload electronically available data and manually input or edit any additional data required to perform the applicable compliance reviews. Specifically, clients using the browser-based direct user interface can submit loan data to a regulatory compliance assessment system in any of three ways:
1. Entirely Manual—The Internet browser-based direct user interface generates dynamic requests for data based on factors such as the loan's address, balance and lien position. Users review physical loan documentation and manually input required information.
2. Fully Automated—Users can submit to a regulatory compliance assessment system any available electronic loan data via a secure Internet browser-based user interface that provides an automated upload tool. Acceptable formats include preformatted standard client-prepared MS Excel spreadsheet/flat file or a standard rating agency or GSE specified data tape.
3. Partly Automated—Generally with whole loan and secondary market transactions, some degree of the data required to determine whether the loan is a “high cost” loan (determined by a high cost review) is unavailable electronically, such as fee data. In such cases, using a direct user interface, users can manually supplement an incomplete loan file that has been pre-populated with any loan data submitted in electronic format.
   Once the direct user interface system determines it has all data required to perform a compliance review, users may submit the loan file for processing. The direct user interface system then accesses the regulatory compliance assessment system to perform those reviews requested by the user. Users may then view compliance review results in the browser-based direct user interface via the regulatory compliance assessment system's standard management reporting feature.

The browser-based direct user interface provides the capability to utilize a unique first pass/second pass functionality. The first pass functionality provides the option to input a limited set of data rather than a more complete and detailed set of data, which is required for a second pass review. The benefit of first pass to users of the regulatory compliance assessment system is that with limited input data, the universe of financial transaction data files that may not comply with a selected compliance rule set, such as potentially high cost mortgage loans, can be reduced significantly. Once the smaller group of potentially non-compliant transaction data files, such as potentially high-cost mortgage loans, has been identified via first pass, users can input more complete and detailed transaction data, such as mortgage loan fee data, for a more precise second pass compliance review. The second pass compliance review determines more accurately if a transaction data file, such as a high cost mortgage loan file, is indeed compliant with the selected compliance rule set. The first pass/second pass methodology significantly limits the amount of effort required to attain a high level of accuracy in identifying noncompliant data files, such as high cost mortgage loans. This results in a significant reduction of data input time without reducing the accuracy of compliance reviews for large sets of transaction data files.

An embodiment of the present invention is a two-pass method for regulatory compliance assessment comprising the steps of populating one or more financial transaction data files with selected limited sets of data to produce a worst-case result when subjecting the transaction data files with limited data sets to compliance assessment with one or more computer-encoded compliance rule sets, using a first pass, assessing compliance of the one or more financial transaction data files having the limited sets of data with the one or more compliance rule sets using a computer-implemented regulatory compliance assessment system resulting in first pass compliant data files and first pass noncompliant data files, populating the first pass noncompliant financial transaction data files with detailed sets of data, using a second pass, assessing compliance of the first pass noncompliant financial transaction data files having the detailed sets of data with the one or more compliance rule sets using the computer-implemented regulatory compliance assessment system resulting in second pass compliant data files and second pass noncompliant data files, and classifying the first pass and second pass compliant data files as being in compliance and the second pass noncompliant data files as not being in compliance with the one or more compliance rule sets by the regulatory compliance assessment system. The step of populating one or more financial transaction data files with selected limited sets of data may comprise populating one or more financial transaction data files with selected limited sets of data for determining compliance with a high cost mortgage loan compliance rule set, comprising selecting an amount paid from borrower's funds at settlement, selecting an amount paid by borrower outside of closing, selecting prepaid interest, selecting total title insurance premiums, selecting total mortgage recording fees and recordation taxes, and selecting total non-borrower paid broker fees. The step of populating one or more financial data files using the limited sets of data may comprise performing a loan lookup and search using a direct user interface, entering and editing a selected set of limited data into one or more financial transaction data files, and validating the limited set of data prior to the first pass. The step of entering and editing may comprise entering and editing limited sets of data for determining potential high cost mortgage loans including an amount paid from borrower's funds at settlement, an amount paid by borrower outside of closing, prepaid interest, total title insurance premiums, total mortgage recording fees and recordation taxes, and total non-borrower paid broker fees. The steps of assessing compliance of the one or more financial transaction data files may comprise the steps of creating the one or more computer-encoded compliance rule sets derived from laws and regulations, storing the one or more computer-encoded compliance rule sets in a regulatory compliance rules repository, assessing regulatory compliance of the one or more financial transaction data files by comparing the one or more financial transaction data files with the one or more computer-encoded compliance rule sets in the regulatory compliance rules repository, and producing a regulatory compliance assessment result for indicating compliance and non-compliance of the one or more transaction data files with the one or more computer-encoded compliance rule sets. The step of populating the first pass noncompliant financial transaction data files with detailed sets of data may comprise selectively loading a selected set of detailed data by batch loading flat files and spreadsheet files into the one or more financial transaction data files, performing a loan lookup and search using a direct user interface, manually entering and editing a selected set of detailed data into the one or more financial transaction data files, and validating the detailed set of data prior to the second pass. The step of manually entering and editing, and selectively loading may comprise entering and editing and selectively loading detailed sets of data for determining high cost mortgage loans including payer and payee of each fee charged at closing and outside of closing. The one or more noncompliant financial data files may be designated as a high cost mortgage loan. The compliance rule set may be selected from the group consisting of Theory of Lending, Home Ownership and Equity Protection Act, State and Local High Cost, Truth in Lending, Predatory Lending, Real Estate Settlement Procedures Act, State and Local Consumer Credit Laws, Lender and Broker Licensing, Home Mortgage Disclosure Act, Office of Foreign Asset Control requirements, Flood Zone Validation, Enterprise Rules, and Customer position Rules. The one or more financial data files may comprise a data file group that is created, modified, populated with sets of data, assessed and classified as compliant and noncompliant as a group. The method may further comprise viewing and printing the noncompliant and compliant financial transaction data files. The limited data sets may be selected from a default limited data template. The detailed data sets may be selected from a default detailed data template.

Another embodiment of the present invention is a two-pass system for regulatory compliance assessment comprising means for populating one or more financial transaction data files with selected limited sets of data to produce a worst-case result when subjecting the transaction data files with limited data sets to compliance assessment with one or more computer-encoded compliance rule sets, a first pass means for assessing compliance of the one or more financial transaction data files having the limited sets of data with the one or more compliance rule sets using a computer-implemented regulatory compliance assessment system resulting in first pass compliant data files and first pass noncompliant data files, means for populating the first pass noncompliant financial transaction data files with detailed sets of data, a second pass means for assessing compliance of the first pass noncompliant financial transaction data files having the detailed sets of data with the one or more compliance rule sets using the computer-implemented regulatory compliance assessment system resulting in second pass compliant data files and second pass noncompliant data files, and means for classifying the first pass and second pass compliant data files as being in compliance and the second pass noncompliant data files as not being in compliance with the one or more compliance rule sets by the regulatory compliance assessment system. The means for populating one or more financial transaction data files with selected limited sets of data may be a direct user interface. The direct user interface may be a web browser based interface communicating with the regulatory compliance assessment system over a secure communication channel. The means for populating the first pass noncompliant financial transaction data files with detailed sets of data may be a direct browser-based user interface and a batch file load interface. The direct user interface may be a browser-based user interface communicating with the regulatory compliance assessment system over a secure communication channel and the batch file load interface communicates with the regulatory compliance assessment system over a secure communication channel for batch loading flat files and spreadsheet files into the one or more selected financial transaction data files. The limited data sets may be selected from a default limited data template. The detailed data sets may be selected from a default detailed data template.

Yet another embodiment of the present invention is a two-pass method for regulatory compliance assessment comprising the steps of populating one or more financial transaction data files with limited data sets for producing a worst case compliance assessment result, performing a first pass compliance assessment of the one or more financial transaction data files with limited data sets resulting in first pass compliant data files and first pass noncompliant data files, populating the first pass noncompliant financial transaction data files with detailed data sets, performing a second pass compliance assessment of the first pass noncompliant data files with detailed data sets resulting in second pass compliant data files and second pass noncompliant data files, and classifying the first pass compliant data files and the second class compliant data files as being compliant with regulatory requirements, and classifying the second pass noncompliant data files as being noncompliant with regulatory requirements. The limited data sets may be selected from a default limited data template. The detailed data sets may be selected from a default detailed data template. The steps of performing compliance assessment of the financial transaction data files may comprise the steps of storing the one or more computer-encoded compliance rule sets in a regulatory compliance rules repository, comparing the financial transaction data files with the one or more computer-encoded compliance rule sets in the regulatory compliance rules repository, and producing a regulatory compliance assessment result for indicating compliance and non-compliance of the transaction data files with the one or more computer-encoded compliance rule sets.

### BRIEF DESCRIPTION OF DRAWINGS

These and other features, aspects and advantages of the present system will become better understood with regard to the following description, appended claims, and accompanying drawings wherein:

FIG. 1 shows a functional diagram of a regulatory compliance assessment system with a direct user interface and a batch input interface;

FIG. 2 shows a block diagram of the direct user input system;

FIG. 3 shows a high-level workflow process diagram for loans captured and reviewed by the direct user interface;

FIG. 4 shows direct user interface functions available for managing a single loan and groups of loans by a loan group manager and a single loan manager;

FIGS. 5A-5J illustrate a drop-down menu of a direct user interface for selecting the functions available for managing a single loan, a group of loans and a template;

FIG. 6A depicts a direct user interface workflow diagram for a loan group search and FIG. 6B shows an associated screenshot;

FIG. 7A depicts a direct user interface workflow diagram for creating a loan group and FIG. 7B shows an associated screenshot;

FIG. 8A depicts a direct user interface workflow diagram for modifying a loan group and FIG. 8B shows an associated screenshot;

FIG. 9A depicts a direct user interface workflow diagram for closing a loan group and FIG. 9B shows an associated screenshot;

FIG. 10 shows a screenshot of a loan group selected using a direct user interface;

FIG. 11A depicts a direct user interface workflow diagram for a single loan search and FIG. 11B shows an associated screenshot;

FIG. 12 depicts a direct user interface workflow diagram for single loan editing and entering single loan data and functional relationships to a single loan search, validation, review submission, and review completion;

FIG. 13 shows a direct user interface screenshot depicting single loan information, property information, loan types and loan terms menus;

FIG. 14 shows a direct user interface screenshot depicting single loan application information, dates from notes, HUD-1 data, TIL disclosures, right to cancel, Section 32 high cost disclosures and loan calculation parameters menus;

FIG. 15 shows a direct user interface screenshot depicting single loan mortgage insurance, buydown and prepayment menus;

FIG. 16 shows a direct user interface screenshot depicting single loan ARM and negative amortization menus;

FIG. 17 shows a direct user interface screenshot depicting a single loan HELOC menu;

FIG. 18A depicts a direct user interface workflow diagram for a single loan data validation and FIG. 18B shows an associated screenshot;

FIG. 19 depicts a direct user interface workflow diagram for a single loan submission for review;

FIG. 20 depicts a direct user interface workflow diagram for a single loan review completion;

FIGS. 21A and 21B depict a direct user interface screenshots for a single loan review results summary;

FIG. 22 depicts a direct user interface screenshot for a single loan asset summary report;

FIG. 23 depicts one pass/two pass methodology that uses a direct user interface, batch load and a regulatory compliance assessment system;

FIG. 24 depicts typical results from subjecting a sample of 5,000 loan files to the one pass/two pass methodology;

FIG. 25A shows a direct user interface screenshot depicting a data entry menu for a first pass of the one pass/two pass methodology;

FIG. 25B shows a direct user interface screenshot depicting a data entry menu for a second pass of the one pass/two pass methodology; and

FIGS. 26A-26E show examples of XML files representing data submitted to a regulatory compliance assessment system for review of prepaid interest, title insurance premiums, total recording fees and recordation taxes, total amount paid by borrower, and total non-borrower paid broker fees.

### DETAILED DESCRIPTION

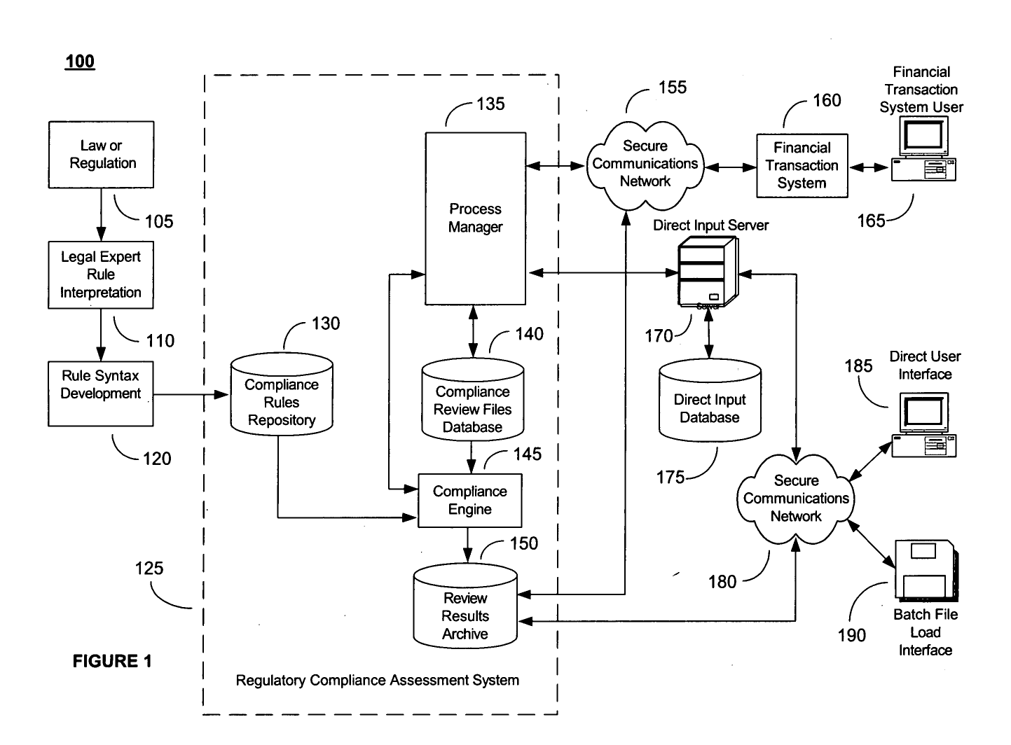

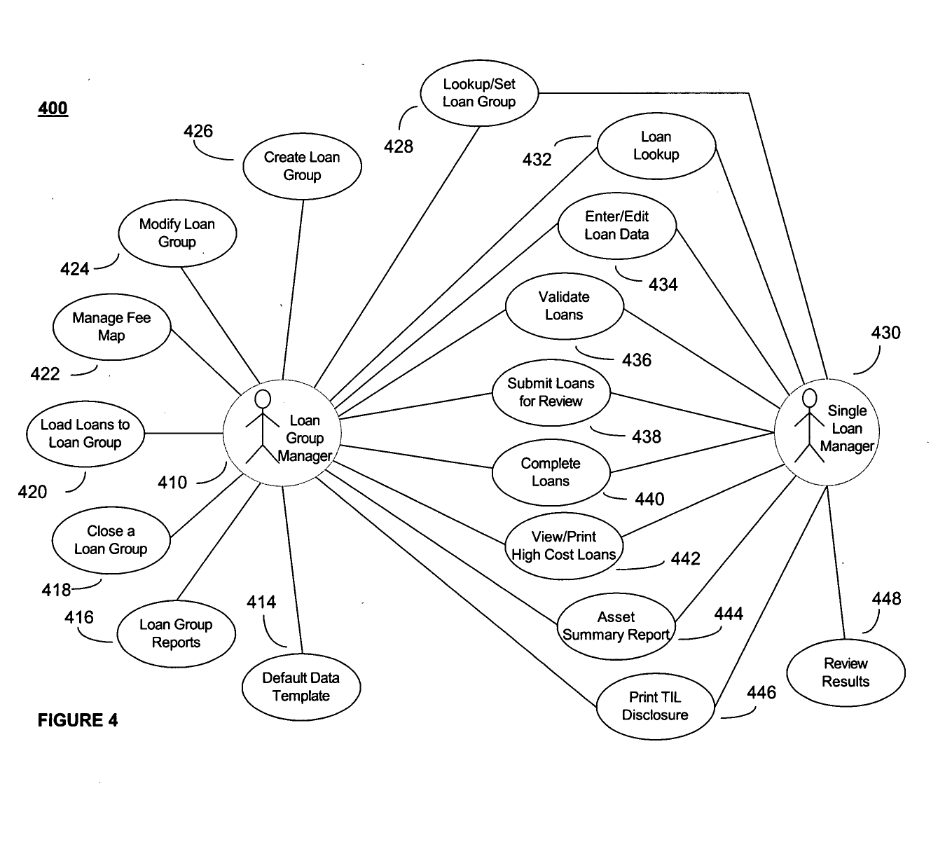

In the following detailed descriptions of FIGS. 1 through 3, the disclosed embodiments apply to regulatory compliance assessment and review that may apply to many fields that involve a substantial level of governmental regulation and oversight. However, in order to illustrate exemplary embodiments of the disclosed invention, the primary and secondary market requirements for home mortgage loans have been chosen because of the breadth of regulatory requirements applicable to this industry. FIGS. 4 through 26 describe embodiments of the present invention applied to these markets.

Turning to FIG. 1, FIG. 1 shows a high level functional diagram of a regulatory compliance assessment system with a direct user interface and a batch input interface 100. When laws or regulations are created or modified 105, legal experts interpret the laws and regulation in terms of rules 110. The rules are then encoded as computer readable procedures and verified 120 by development and quality assurance personnel. After verification is complete, the encoded rules are stored in a compliance rules repository 130 of a regulatory compliance assessment system 125. When a process manager 135 in the regulatory compliance assessment system 125 receives financial transaction data files from a financial transaction system 160 via a secure communications network 155, the data files are stored in a compliance review files database 140. The compliance engine 145 then compares the stored data file with the rules stored in the compliance rules repository 130 to determine a result that is stored in a review results archive 150. The results files are then sent from the review results archive 150 to the financial transaction system 160 via the secure communications network 155.

The direct user interface 185 is a web browser-based interface that communicates with a direct input server 170 via a secure communications network 180. It may be used to search, create, edit and save financial transaction data files stored in a direct input database 175 connected to the direct input server 170. The direct user interface 185 manages single transaction data files as well as groups of transaction data files and submits them via the direct input server 170 to the regulatory compliance assessment system 125 for review. The direct user interface 170 can also control loading groups of financial transaction data files from the batch file load interface 190 into the direct input database 175. When the direct input server 170 submits financial transaction data files for review by the regulatory compliance assessment system 125, the process manager 135 receives files stored in the direct input database 175 and submits the data files directly to the compliance engine 145 for review. The compliance engine 145 then compares the data file with the rules stored in the compliance rules repository 130 to determine a results that are returned as results files to the direct input server 170 for transmittal to the direct user interface 185. The results files may also be sent to the review results archive 150 for access by the direct user interface via the secure communications network 180.

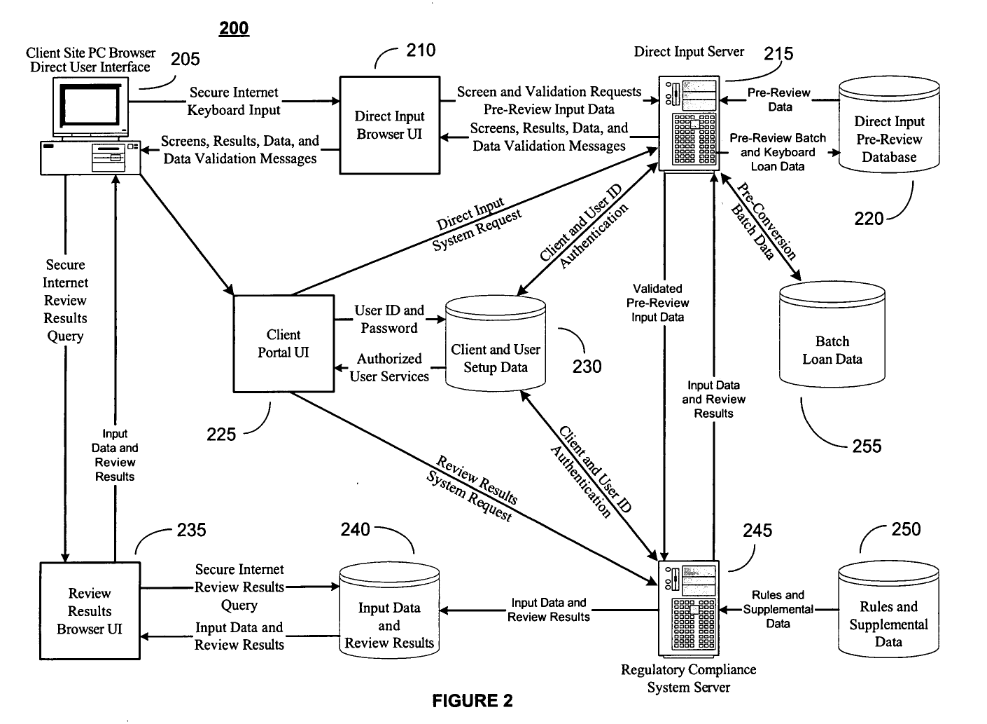

Turning to FIG. 2, FIG. 2 shows a block diagram 200 of the direct user input system. A user of the direct user interface 205 must first log on the system by submitting a user ID and password to a client portal user interface 225. Client and user data is stored in a client and user setup database 225. When logged on the system, a user of the direct user interface 205 is able to communicate over a secure communications channel with a direct input server 25 via a direct input browser user interface 210. A direct user interface user has available all of the functions described in relation to FIG. 4 for managing loan groups and single loans. Created and edited loan data files are stored in the direct input pre-review database 220. A user is able to search, select, edit, save, and submit loan data files to a regulatory compliance system server 245 for compliance assessment review, where the input data is compared with rules stored in the rules and supplemental database 250. The direct user interface 205 is able to access results data either via the direct input server 215 via the direct input browser user interface or from the input data and review results database 240 via the review results browser user interface 235. The direct user interface 205 is also able to control loan file groups or batches, which may be input via a secure communications channel and stored in the batch loan database 255.

Batch processing of data files in the direct input system provides users the ability to upload electronic data for input into the system 100 via the batch load database 255. Users can select from a standard set of batch formats which prescribe the order, size, and type of data contained in excel spreadsheet format, comma delimited format, or pipe delimited format. Users log on the client portal user interface 225 from the direct user interface browser 205, select direct input interface, and select batch upload. They are then presented with a screen that requires them to declare the type of file they are uploading; the group ID, if any, that they want assigned to the profile; and a default template, if any, that they want applied to the batch. The batch file is then transmitted to the direct input server 310 where it is stored in its original format in the batch loan database. The direct input server 215 automatically converts and translates this data into XML format and values that are used by the system. The converted/translated data is loaded into the direct input pre-review database 220. Users are notified when the batch upload is complete. When users log on the direct input system after the batch upload process is complete, they can select the loan group ID that was assigned to the batch and review all the loans in the batch. Users can then input additional required data as appropriate, change data as desired, and submit loans for review to regulatory compliance system server 245.

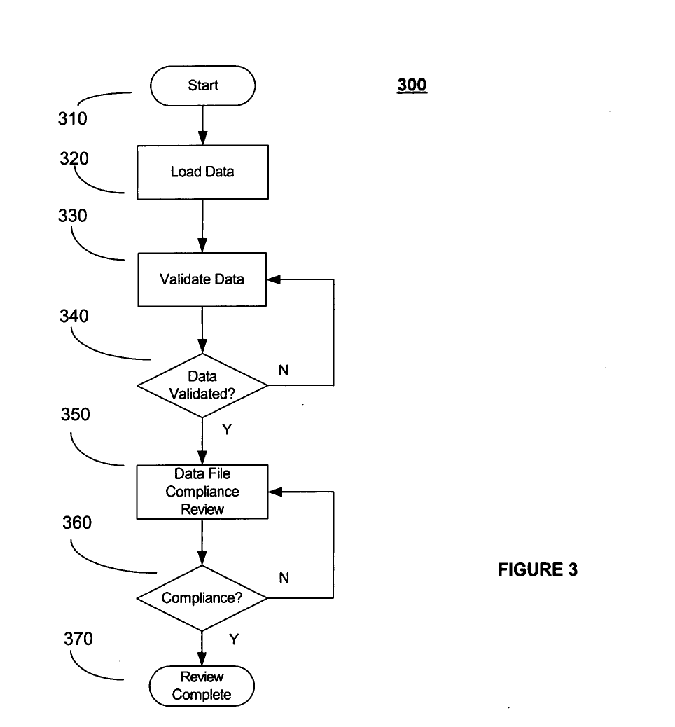

Turning to FIG. 3, FIG. 3 shows a high-level workflow process diagram 300 for data transactions captured and reviewed by the direct user interface. At the start of the process 310, data is loaded into the system 320. At this point, the only guarantee is that the customer ID, batch ID and loan ID are defined. The user can load data files through either manual user input or through a batch mechanism. This is represented by the data load state 320. Once data is loaded 320, it is run through a data validator 320 and, upon successful completion, it is in the data reviewed state 340. This means that the data has passed data review for required fields, formats and data correctness. If the data is not validated 340, further editing of the data is required for validation 330. Only after data has successfully passed the data validator 340 can it be run through the compliance assessment system for compliance review 350. When the data file has passed through the compliance review 350, it is known whether the data file is in compliance 360 with regulatory requirements and the review is complete. The data files may be edited and resubmitted for review. When the user has completed working with a data file, the loan is set to review complete 370, whether or not it is in compliance 360.

When applying the disclosed direct input capability to regulatory assessment compliance requirements for the primary and secondary markets in home mortgage loans, there are a number of requirements. These include:
Fees mapping between client fee IDs and system fee IDs
Field data validation improves the quality of the data entering the system
Format control ensures that input data meets specific formatting requirements
Data range control provides additional quality to user input data
Cross validation between data fields
Input data must validate against a schema prior to system entry
First pass/second pass review
HUD-1 fee screens
Identify originating lender
Default data templates

In addition to the requirements above, when applying the disclosed batch input capability to regulatory assessment compliance requirements for the primary and secondary markets in home mortgage loans, there are also a number of requirements.

These include:

Field data validations
Loan and fee data translation
Batch ID and batch control mechanism
Accept rating agency tape files
Accept point file format
Accept standard secondary market formats

Turning to FIG. 4, FIG. 4 shows direct user interface functions available for managing a single mortgage loan and groups of mortgage loans by a loan group manager and a single loan manager. These direct user interface functions enable the requirements listed above to be met with the disclosed invention. FIG. 4 illustrates the functions available to a loan group manager and a single loan manager, some of which are common to both. Some of these functions are described in greater detail below. Functions common to both the loan group manager and the single loan manager include loan group lookup 428, single loan lookup 432, enter/edit loan data 434, validate loans 436, submit loan for review 438, complete loans 440, view/print high cost loans 442, asset summary report 444, and print a TIL disclosure. Review results 448 are also available to the single loan manager. Functions available to only the loan group manager include create loan group 426, modify loan group 424, manage fee map 422, load loans to loan group 420, close loan group 418, loan group reports 416, and default data template 414.

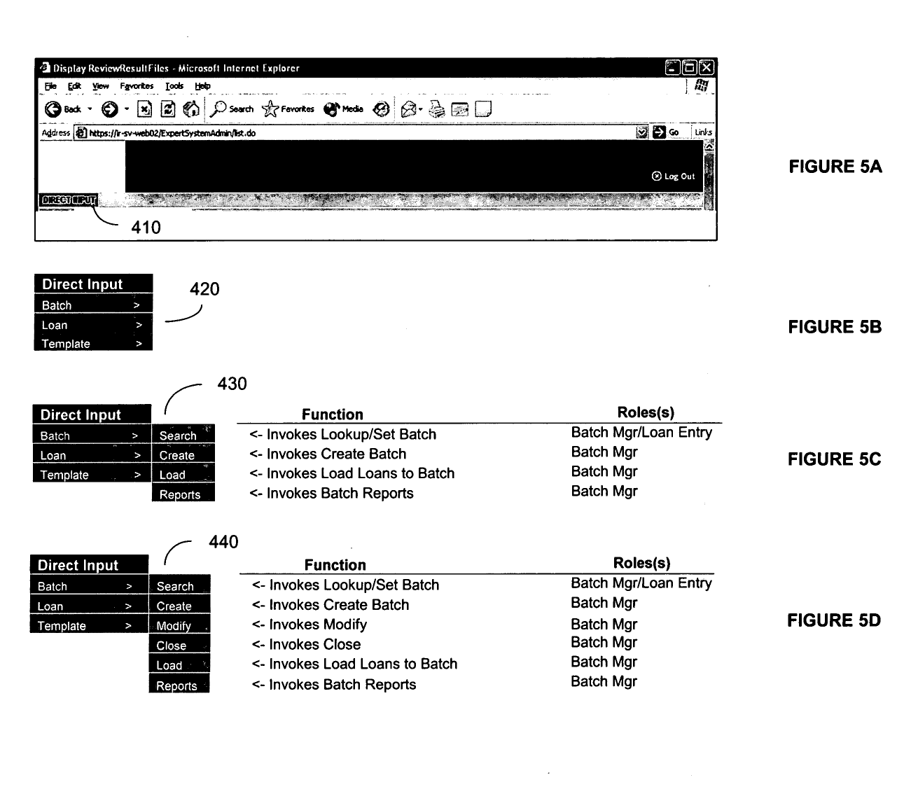

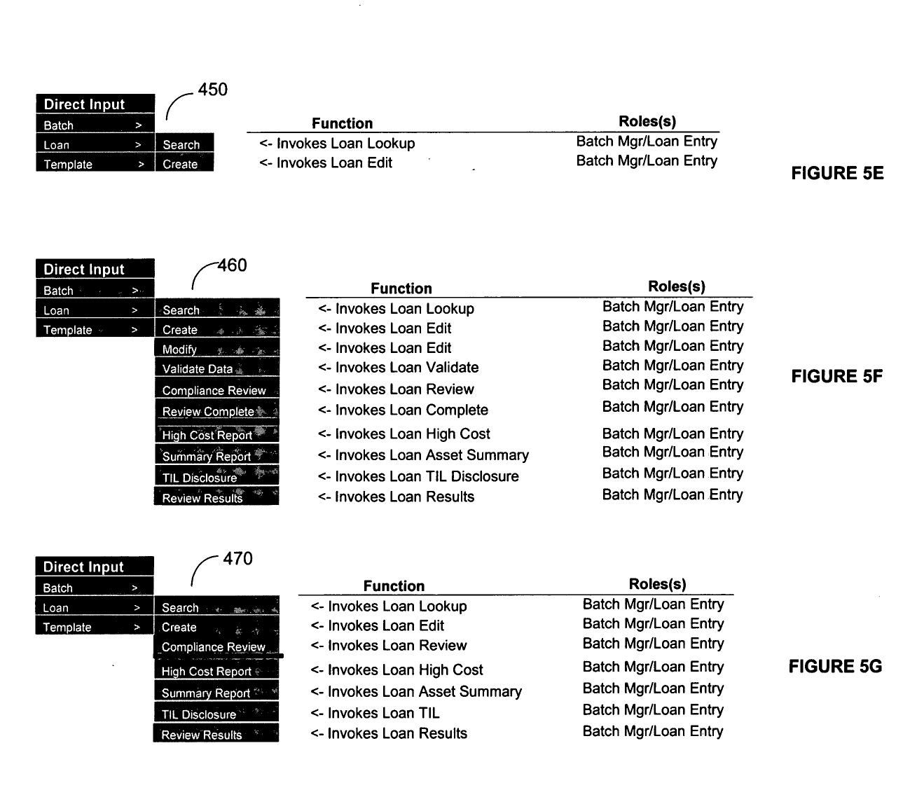

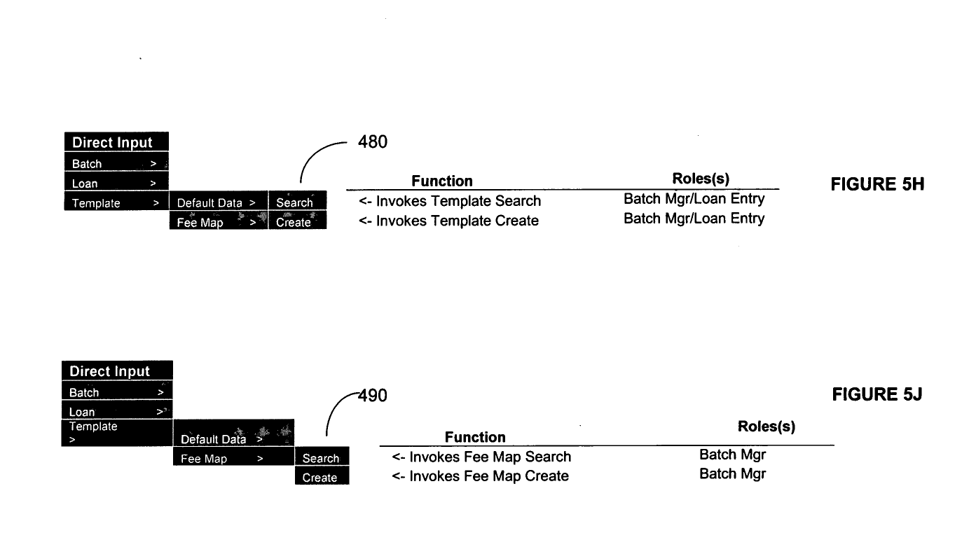

Turning to FIG. 5, FIGS. 5A-5J illustrate a drop-down menu of a direct user interface for selecting the functions available for managing a single loan, a group of loans and a template. FIG. 5A shows the Direct Input button 410 on the web browser direct user interface. When the Direct Input button 410 is selected, a drop-down menu 420 appears as shown in FIG. 5B for providing selection of Batch, Loan, or Template. The Direct Input menu 420 has three sub-menus—one for Batch management, one for Loan creation, and one for Template management. When Batch is selected with no active batch selected, the Batch menu 430 appears as shown in FIG. 5C. This includes all functions for managing batches including Search for invoking lookup/set batch (see 428 in FIG. 4), Create for invoking create batch (see 426 in FIG. 4), Load for invoking load loans to batch (see 420 in FIG. 4), and Reports for invoking batch reports (see 416 in FIG. 4). When Batch is selected for an active batch, the Batch menu 440 appears as shown in FIG. 5D. This includes all functions for managing and editing batches including Search for invoking lookup/set batch (see 428 in FIG. 4), Create for invoking create batch (see 426 in FIG. 4), Modify for invoking modify (see 424 in FIG. 4), Close for invoking close (see 418 in FIG. 4), Load for invoking load loans to batch (see 420 in FIG. 4), and Reports for invoking batch reports (see 416 in FIG. 4).

When the Loan submenu is selected with no active loan selected, the Loan submenu 450 appears, as shown in FIG. 5E. It includes Search for invoking loan lookup (see 432 in FIG. 4) and Create for invoking loan creation and editing (see 434 in FIG. 4). When a loan is selected, several additional menu items appear, as shown in FIG. 5F. These items remain active as long as the Loan is not marked for Review Complete. The dark separator in the menu separates loan activities from reports. The submenu 460 includes Search for invoking loan lookup (see 432 in FIG. 4), Create for invoking loan creation and editing (see 434 in FIG. 4), Modify for invoking loan edit (see 434 in FIG. 4), Validate Data for invoking loan validate (see 436 in FIG. 4), Compliance Review for invoking loan review (see 438 in FIG. 4), Review Complete for invoking loan complete (see 440 in FIG. 4), High Cost Report for invoking loan high cost (see 442 in FIG. 4), Summary Report for invoking loan asset summary (see 444 in FIG. 4), TIL Disclosure for invoking loan TIL disclosure review (see 446 in FIG. 4), and Review Results for invoking loan results (see 448 in FIG. 4). If the loan has been marked as Review Complete, the loan data can no longer be modified, as shown in FIG. 5G. In this case, the menu selections only allow the selection of new loans, running the compliance check for an existing loan, or the reporting on the completed loan file. The submenu 470 includes Search for invoking loan lookup (see 432 in FIG. 4), Create for invoking loan creation and editing (see 434 in FIG. 4), Compliance Review for invoking loan review (see 438 in FIG. 4), High Cost Report for invoking a high cost report (see 442 in FIG. 4), Summary Report for invoking loan asset summary (see 444 in FIG. 4), TIL Disclosure for invoking loan TIL disclosure review (see 446 in FIG. 4), and Review Results for invoking loan results (see 448 in FIG. 4).

When the Template submenu is selected, the user has a choice of selecting Default Data as shown in FIG. 5H, or Fee Map as shown in FIG. 5J. When Default Data is selected 480 (see 414 in FIG. 4), the submenu includes Search for invoking template search and Create for invoking template create. When Fee Map is selected 490 (see 422 in FIG. 4), the submenu includes Search for invoking fee map search and Create for invoking fee map create.

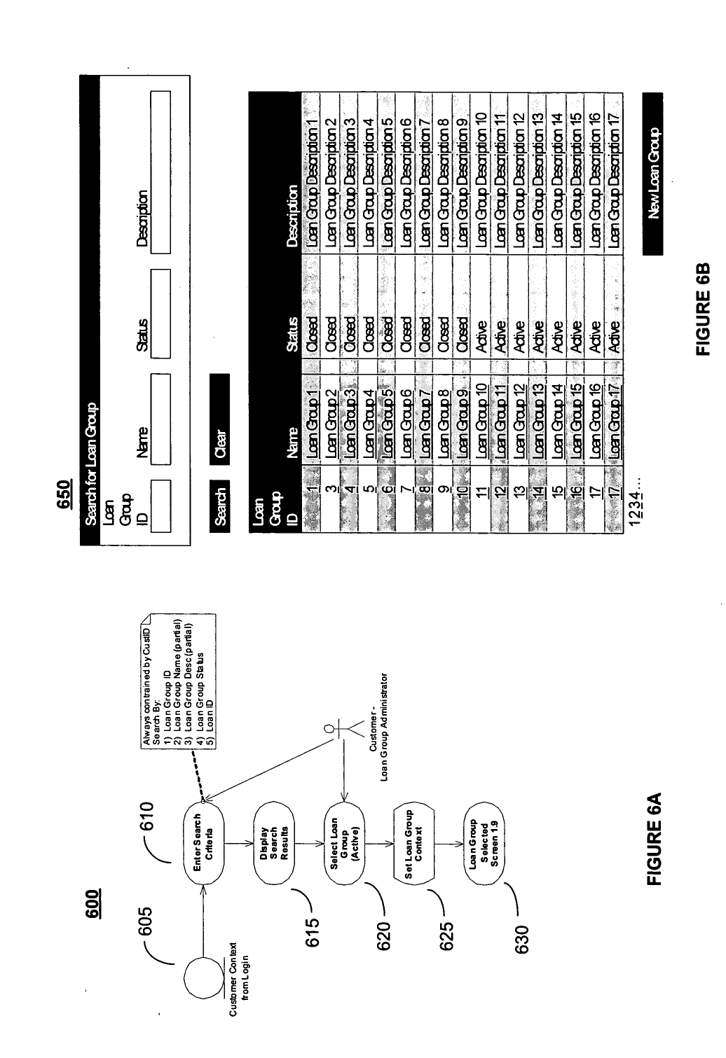

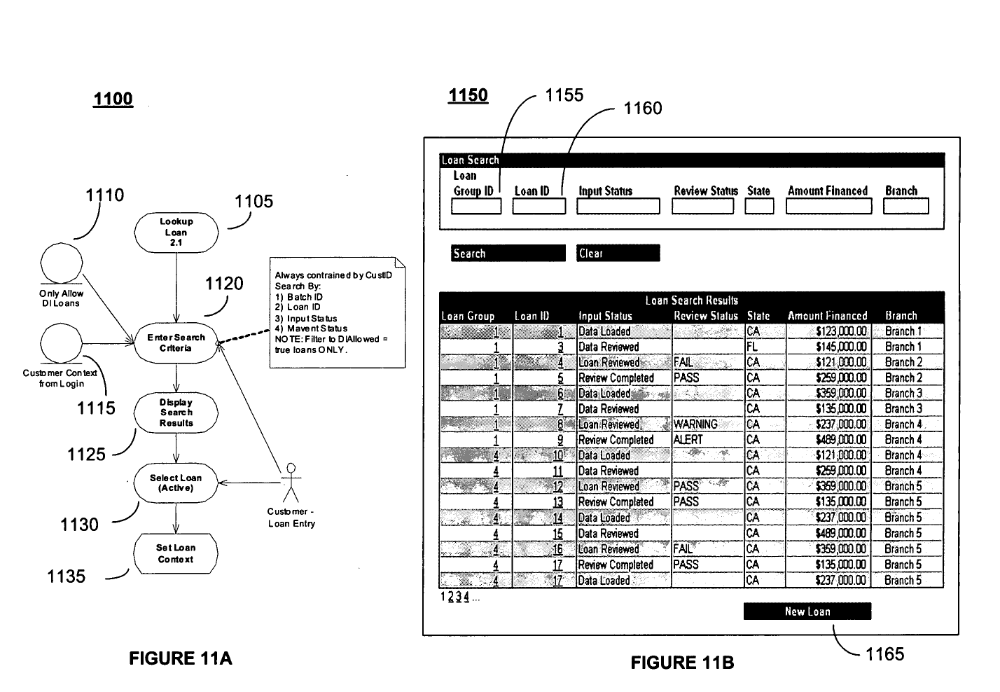

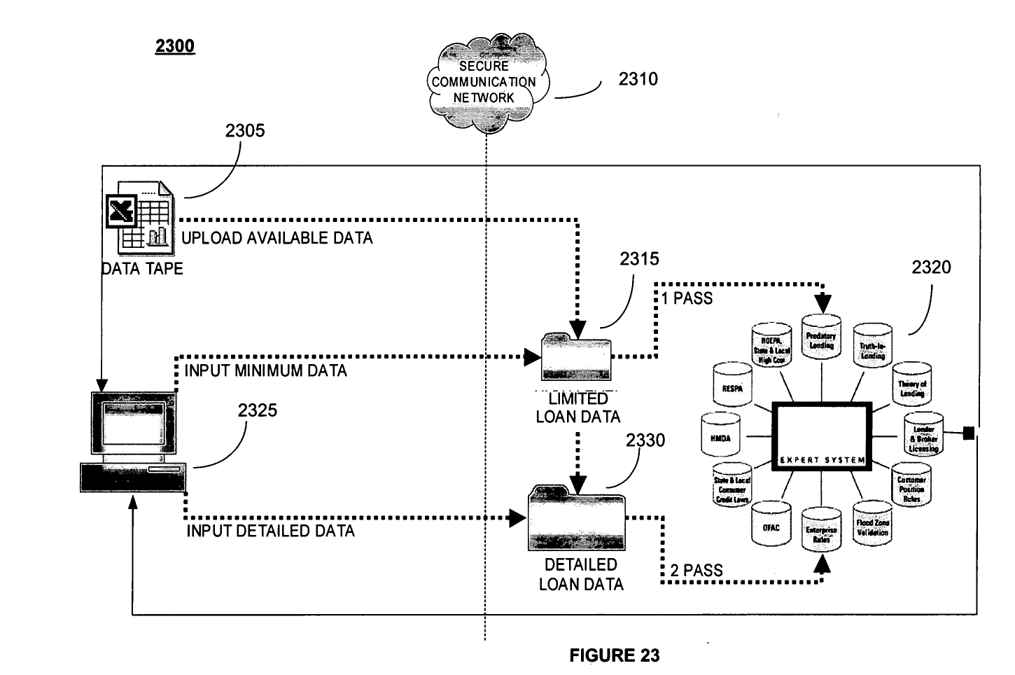

Loan Group functionality allows users to manage a group of loans. FIGS. 6-10 focus on the creation and maintenance of loan groups. FIGS. 11-22 focus on the creation and maintenance of single loans, although there are many common functions, as shown in FIG. 4. FIGS. 23-26 focus on the issue of fees, and more particularly, examples of fees contributing to high cost mortgage loans and the one pass/two pass methodology.

Turning to FIG. 6, FIG. 6A depicts a direct user interface workflow diagram for a loan group search 600 (see 428 in FIG. 4 and FIGS. 5A, 5B, 5C and 5D) and FIG. 6B shows an associated screenshot 650. Basic search functionality exists to allow loan group manager users to find a Loan Group and then route to loans within the Loan Group. Customer context 605 is determined at login as being either a loan group manager or a single loan manager. A search criteria is entered 610, which is always constrained by customer ID. Search criteria may be selected from loan group ID, loan group name, loan group description, loan group status, and loan ID, as shown in the upper portion of FIG. 6B. The search results are then displayed 615 as shown in the lower portion of FIG. 6B. A loan group is selected 620, a loan group context is set 625, and a loan group selected screen is displayed 630 to a loan group manager.

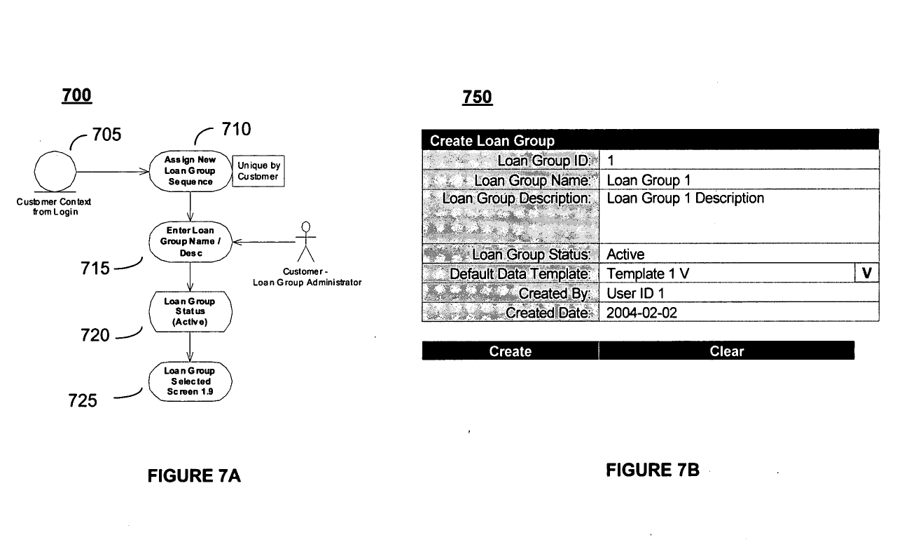

Turning to FIG. 7, FIG. 7A depicts a direct user interface workflow diagram for creating a loan group 700 (see 426 in FIG. 4 and FIGS. 5A, 5B, 5C and 5D) and FIG. 7B shows an associated screenshot 750. The logon determines the context 705 of whether the user is enabled as a loan group manager or a single loan manager. The loan group manager user assigns a new loan group sequence 710 that is unique by customer, enters a loan group name and description 715, enters a loan group status as active 720, and the loan group selected screen is displayed 725. FIG. 7B depicts a screenshot 750 of data as entered by the loan group manager.

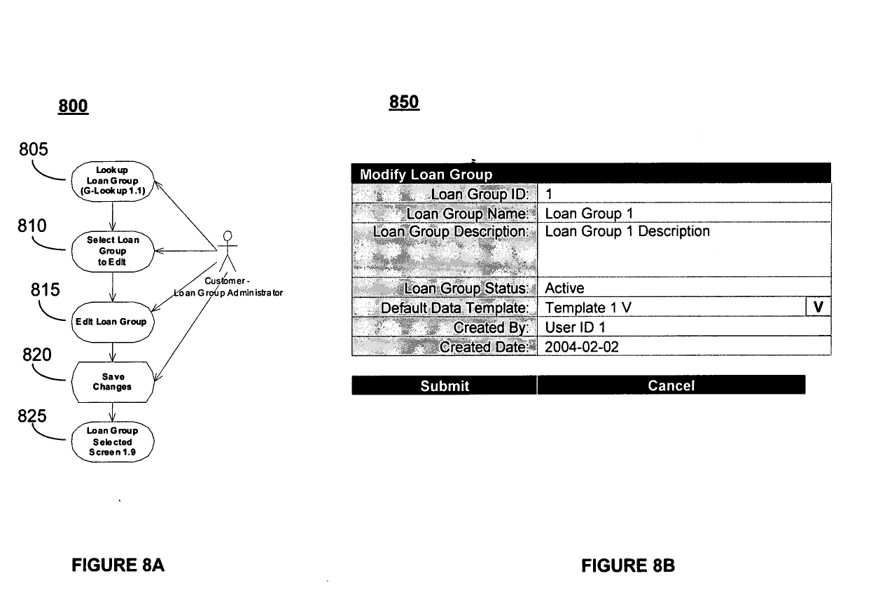

Turning to FIG. 8, FIG. 8A depicts a direct user interface workflow diagram for modifying a loan group 800 (see 424 in FIG. 4 and FIGS. 5A, 5B, 5C and 5D) and FIG. 8B shows an associated screenshot 850. The loan group manager user looks up loan groups 805, selects a loan group for editing 810, edits the loan group 820, and the modified loan group selected screen is displayed 825. FIG. 8B depicts a screenshot 850 of this data as entered by the loan group manager.

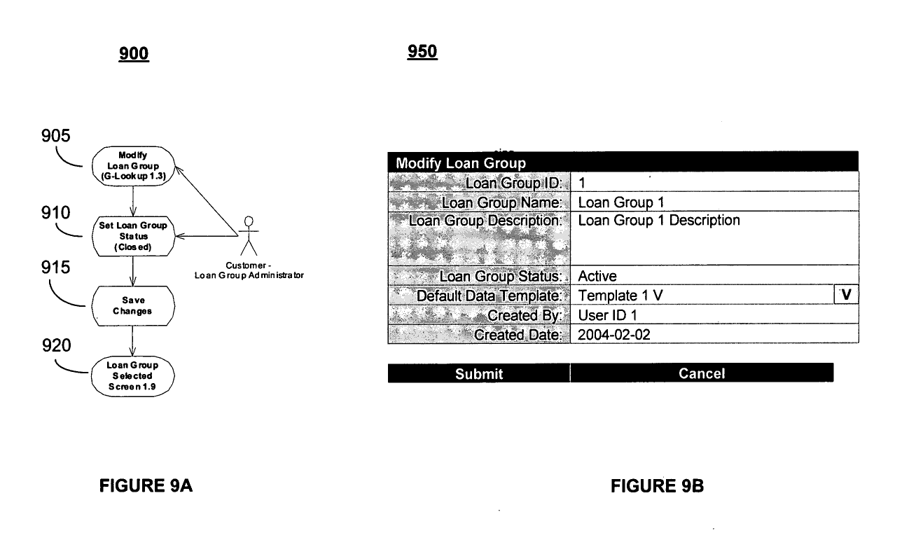

Turning to FIG. 9, FIG. 9A depicts a direct user interface workflow diagram for closing a loan group 900 (see 418 in FIG. 4 and FIGS. 5A, 5B, 5C and 5D) and FIG. 9B shows an associated screenshot 950. The loan group manager user completes modifying a loan group 905, sets the loan group status as closed 910, saves the changes 915, and closed work group selected screen is displayed 920. FIG. 9B depicts a screenshot 950 of this data as entered by the loan group manager.

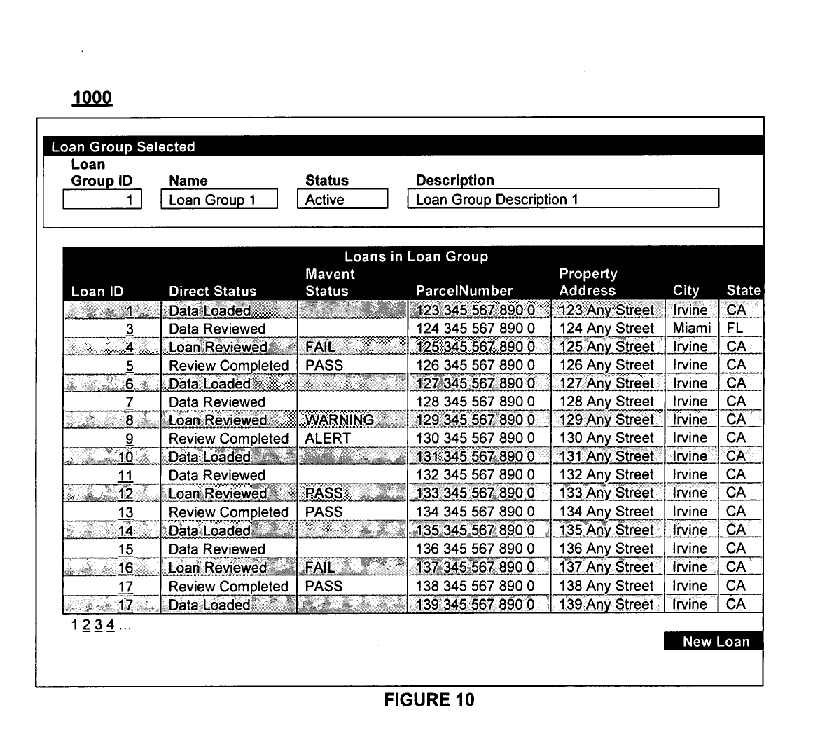

Turning to FIG. 10, FIG. 10 shows a screenshot of a loan group selected 1000 using a direct user interface. The loan group selected screen is a landing point for any activities surrounding loan group activity. After a loan group has been created, modified or closed, it returns to this screen 1000 to display the related loan information.

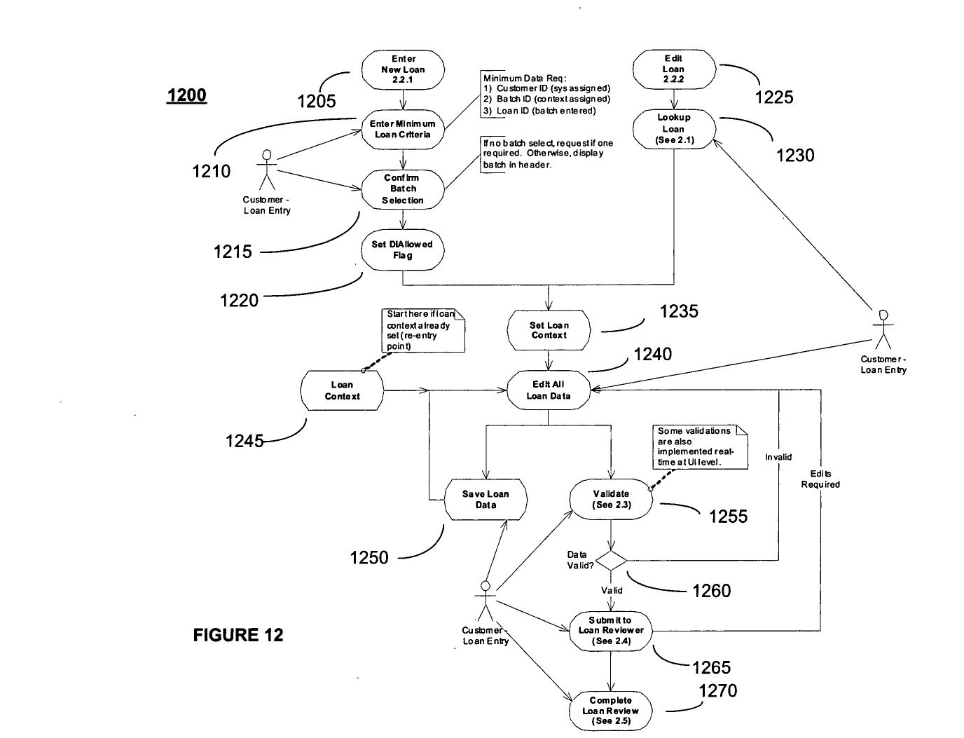

Turning to FIG. 11, FIG. 11 A depicts a direct user interface workflow diagram for a single loan search 1100 (see 432 in FIG. 4 and Figures 5A, 5E, 5F and 5G) and FIG. 11B shows an associated screenshot 1150. To perform a loan lookup 1105, a loan manager user enters a search criterion 1120 where only direct user input loans are allowed 1110 and logon determines the context 1115 of whether the user is enabled as a loan group manager or a single loan manager. The search 1120 is always constrained by a customer ID, and search criterion is selected from batch ID, or loan ID, input status. The upper portion of the associated screenshot 1150 depicts entry of search criteria. One or more criteria can be completely or partially entered. The search will then return the results as depicted in the lower portion of FIG. 11B. A hyperlink from the batch ID 1155 will go to the modify batch screen (see 424 in FIG. 4 and FIGS. 9A and 9B). A hyperlink from the loan ID 1160 will go to the loan edit screens (see 434 in FIG. 4 and FIG. 12). The new loan button 1165 initiates a new loan and is ready for editing (see 434 in FIG. 4 and FIG. 12). When the search results are displayed 1125 as depicted in the lower portion of the associated screenshot 1150, a loan is selected 1130 and a context for the loan is set 1135.

Turning to FIG. 12, FIG. 12 depicts a direct user interface workflow diagram 1200 for single loan editing and entering single loan data (see 434 in FIG. 4), as well as functional relationships to a single loan search 1230, validation 1255, review submission 1265, and review completion 1270. A loan manager user may edit an existing loan 1225 by performing a loan lookup 1230 (see 432 in FIG. 4) and setting a loan context 1235, or by entering a new loan 1205 by entering minimum loan criteria 1210, confirming a batch selection 1215, setting a “direct input allowed” flag 1220 and setting the loan context 1235. The minimum loan criteria 1210 includes customer ID, batch ID, and loan ID. When the loan context has been set 1235 or the loan context has been previously set 1245, all loan data is edited 1240 and saved 1250. The loan data is then validated 1255 (see 436 in FIG. 4) and submitted for loan review 1265 (see 438 in FIG. 4). If the data is found to be invalid 1260, or the review 1265 is unsuccessful, additional edits 1240 may be required. The loan review is then completed 1270 (see 440 in FIG. 4).

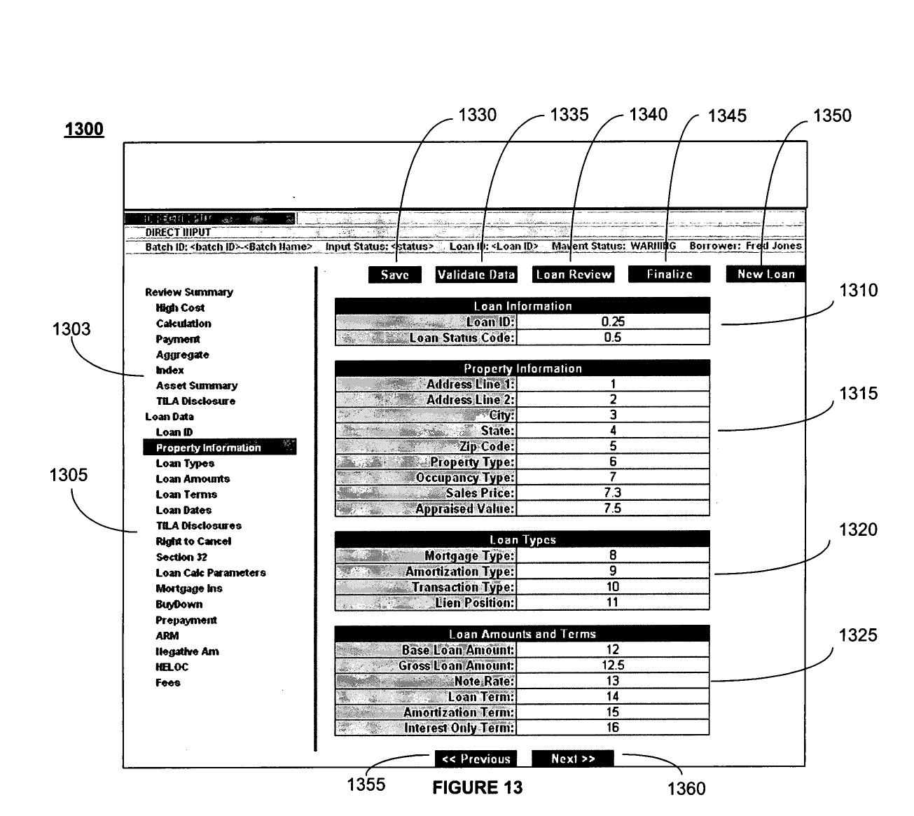

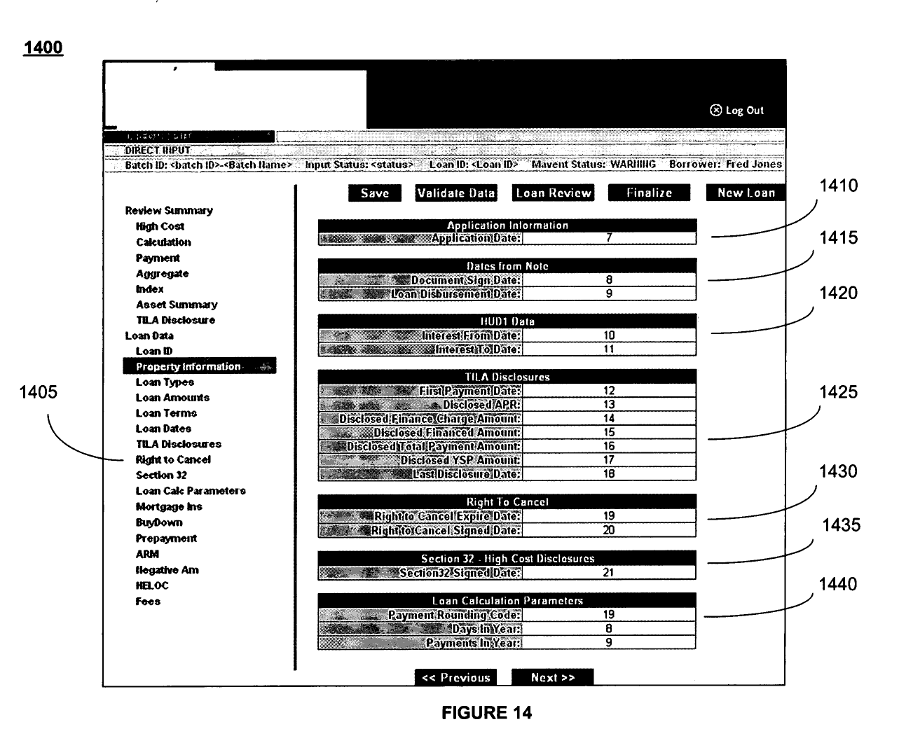

Turning to FIG. 13, FIG. 13 shows a direct user interface screenshot depicting a general navigation screen 1300 as well as single loan information 1310, property information 1315, loan types 1320 and loan terms menus 1325. The general navigation elements of FIG. 13 are identical to subsequent FIGS. 14 through 18B, and 25. General navigation features include review summary selections 1303, loan data selections 1305, save button 1330, validate data button 1335, loan review button 1340, finalize 1345, new loan 1350, previous 1355, and next 1360. The save button 1330 persists the current data to a permanent data store, while the selected loan data remains on the current screen. The validate data button 1335 validates the entire loan file against the required formats and field level validations. The loan review button 1340 submits the loan data file for review by the associated regulatory compliance assessment system, and the results are returned to the direct user input interface, when a review summary menu 1303 is enabled. The finalize button 1345 sets the input status to “review complete”, indicating that no further changes are required in this loan file. The new loan button 1350 saves the existing loan data, clears all data fields, populates the default data for a loan, and begins in “edit” mode for the loan. The previous button 1355 moves the screen to the previous loan data screen. The next button 1360 moves the screen to the next loan data screen. For selection of specific information concerning loan data, the loan data selections 1305 enable display of selected screens, such as loan information 1310, property information 1315, loan types 1320 and loan amounts and terms 1325, as shown in FIG. 13.

Turning to FIG. 14, FIG. 14 shows a direct user interface screenshot 1400 for the Right to Cancel screen depicting a single loan's application information 1410, dates from the promissory notes 1415, HUD-1 data 1420, TIL disclosures 1425, right to cancel notice 1430, and the Section 32 high cost disclosures 1435 and loan calculation parameters for the loan 1440. The selection of these specific screen displays is accomplished by selecting the corresponding item in the loan data menu 1405.

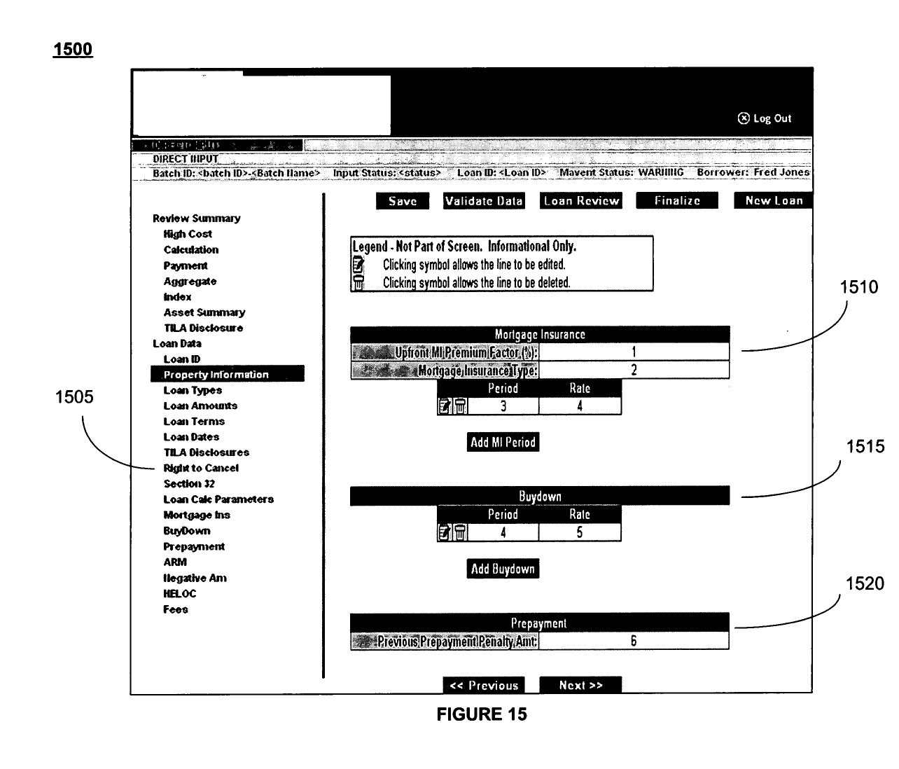

Turning to FIG. 15, FIG. 15 shows a direct user interface screenshot 1500 depicting single loan mortgage insurance 1510, buydown 1515 and prepayment information menus 1520. The selection of these specific screen displays is accomplished by selecting the corresponding item in the loan data menu 1505.

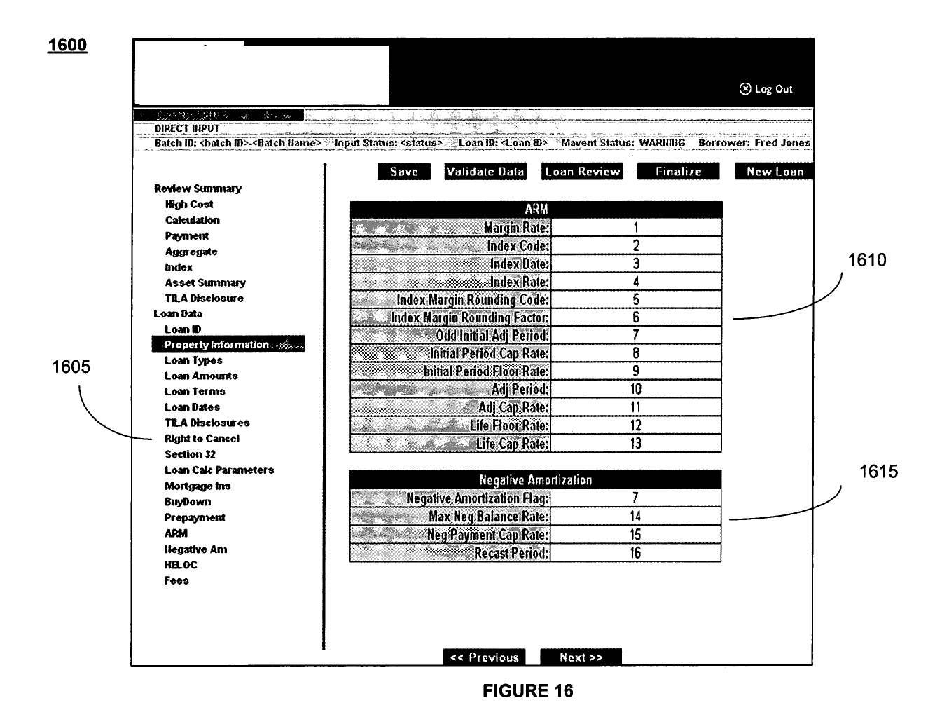

Turning to FIG. 16, FIG. 16 shows a direct user interface screenshot 1600 depicting a single loan Adjustable Rate Mortgage (ARM) 1610 and negative amortization 1615 menus. The selection of these specific screen displays is accomplished by selecting the corresponding item in the loan data menu 1605.

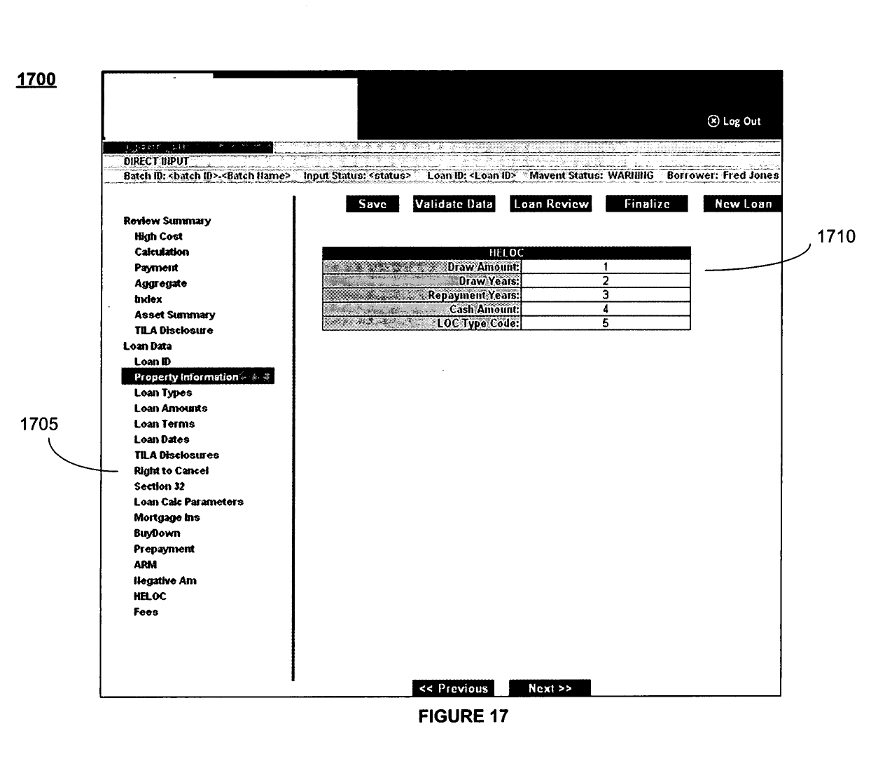

Turning to FIG. 17, FIG. 17 shows a direct user interface screenshot 1700 depicting a single loan Home Equity Line Of Credit (HELOC) menu 1710. The selection of these specific screen displays is accomplished by selecting the corresponding item in the loan data menu 1705.

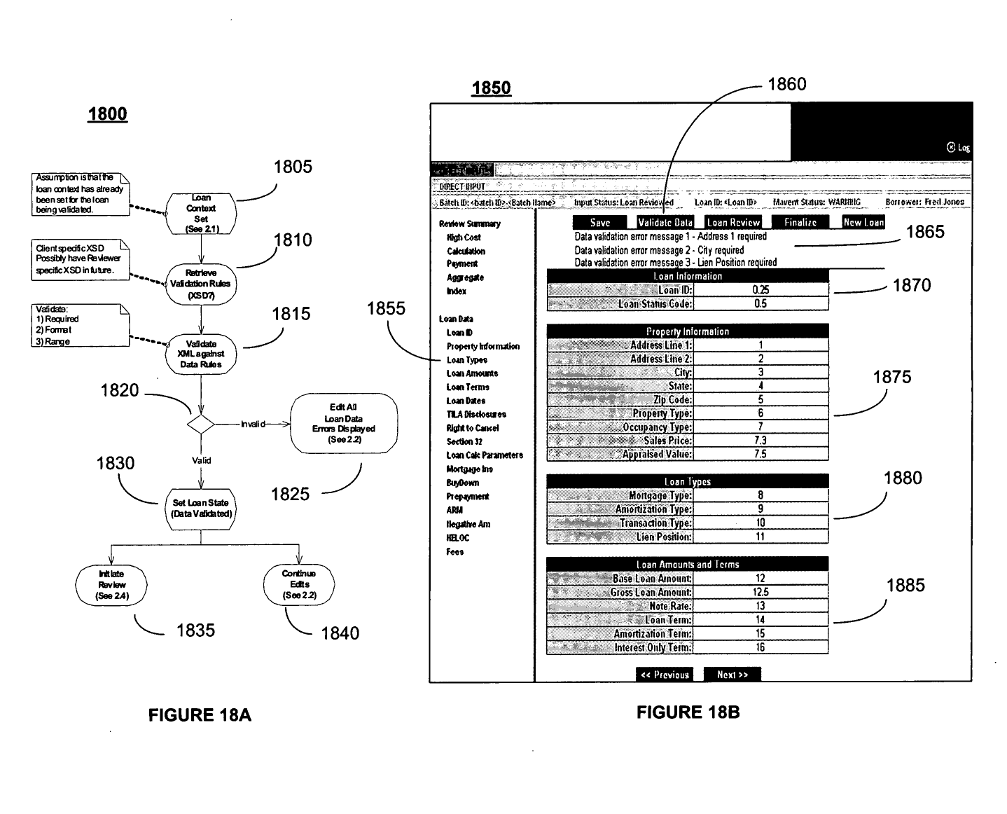

Turning to FIG. 18, FIG. 18A depicts a direct user interface workflow diagram 1800 for a single loan's data validation and FIG. 18B shows an associated screenshot 1850. A loan manager user must set the loan context 1805 (see 432 in FIG. 4), retrieve the validation rules 1810, validate the data against the rules 1815 for format and range, and determine if the data is valid or invalid 1820. If the data is invalid 1820, the user is required to edit the data errors displayed 1825. If the data is valid 1830, the loan state is set as validated 1830 and the user may initiate a compliance review 1835 (see 438 in FIG. 4) or continue editing 1840 (see 434 in FIG. 4). FIG. 18B depicts a screenshot 1850 that illustrates a negative result from a validity check that is performed by selecting the validate data button 1860. Validation error messages 1865 (numbers 1, 2, and3) are shown near the top of the screen, as well as a loan information menu 1870, a property information menu 1875 having a missing address corresponding to error messages 1 and 2, a loan type menu 1880 having missing lien information corresponding to error message 3, and a loan amount and terms menu 1885. The selections under the loan data menu 1855 corresponding to the error message related menus (property information and loan types) are highlighted.

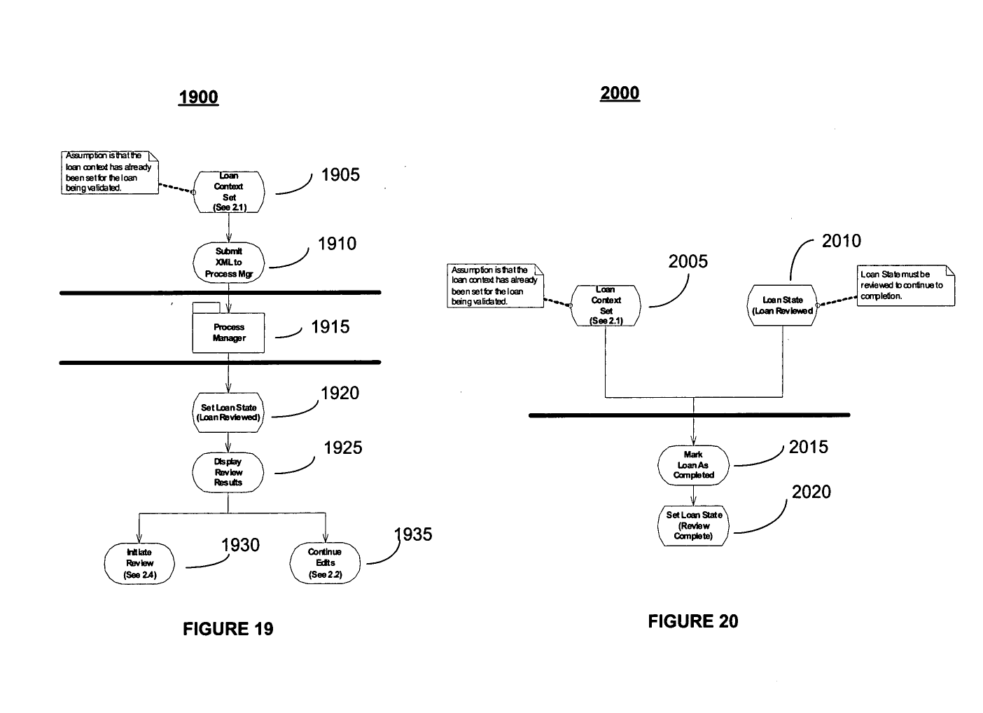

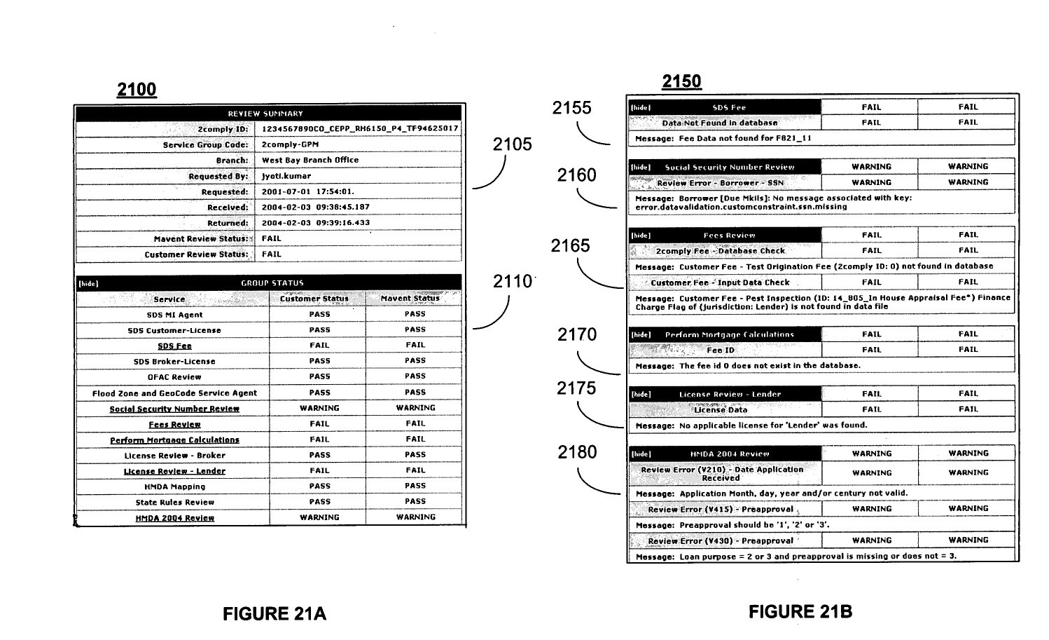

Turning to FIG. 19, FIG. 19 depicts a direct user interface workflow diagram 1900 for a single loan submission for review (see 438 in FIG. 4). A loan manager user must set the loan context 1905 (see 432 in FIG. 4), submit the loan data file 1910 (preferably in XML format) to the process manager 1915 of regulatory compliance assessment system for review. The loan state is set to “reviewed” 1920 and the review results are displayed 1925, as shown in FIGS. 21A and 21B. The user may then initiate another review 1930 (see 438 in FIG. 4) or may continue editing the selected loan file 1935 (see 434 in FIG. 4).

Turning to FIG. 20, FIG. 20 depicts a direct user interface workflow diagram 2000 for a single loan review completion (see 440 in FIG. 4). A loan manager must ensure that the loan context is set 2005 (see 432 in FIG. 4) or the loan state is set to “reviewed” 2010. The loan is then marked as completed 2015 and the loan state is set to “review complete” 2020.

Turning to FIG. 21, FIGS. 21A and 21B depict direct user interface screenshots 2100, 2150 for a single loan review results summary (see 448 in FIG. 4). The first screenshot 2100 illustrates a review summary 2105 and a group status 2110. The second screenshot 2150 illustrates SDS fee 2155, social security number review 2160, fees review 2165, perform mortgage calculations 2170, lender license review 2175, and HMDA 2004 review 2180.

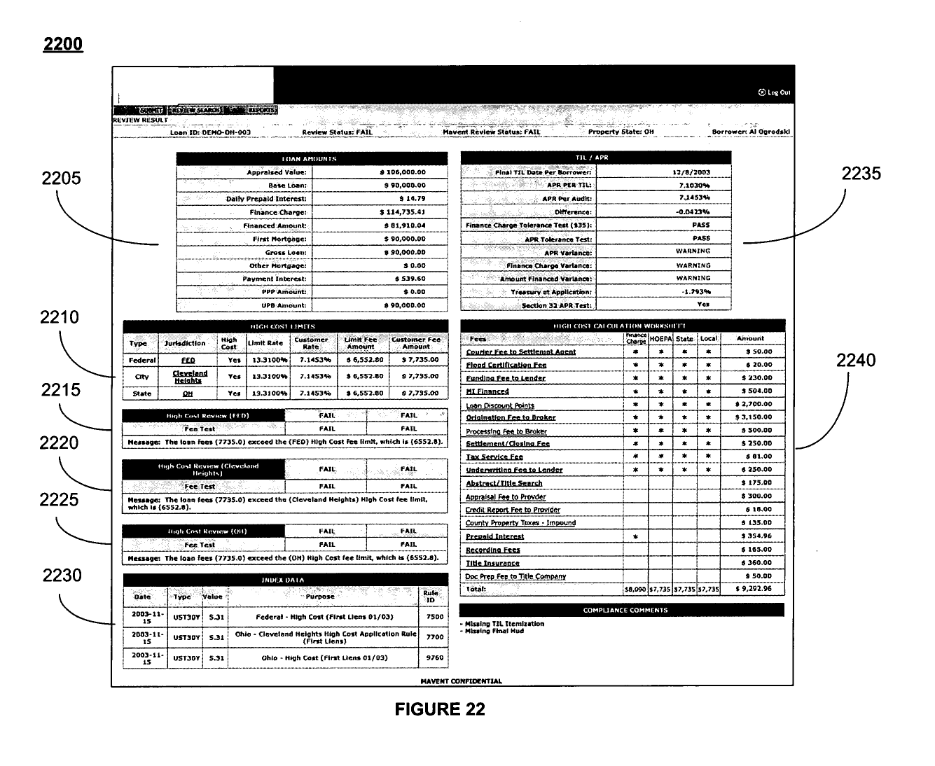

Turning to FIG. 22, FIG. 22 depicts a direct user interface screenshot 2200 for a single loan asset summary report (see 444 in FIG. 4). A user selects a desired report from the review summary menu and is presented with the screen shown in FIG. 22. The screenshot includes loan amounts 2205, high cost limits 2210, Federal high cost review 2215, high cost review for Cleveland Heights 2220, high cost review for Ohio 2225, index data 2230, TIL/APR 2235, and high cost calculation worksheet 2240.

Turning to FIG. 23, FIG. 23 depicts one pass/two pass methodology 2300 that uses a direct user interface 2325, batch load facility 2305, and a regulatory compliance assessment system 2320. A first pass comprises uploading data files with limited minimum data from the batch load facility 2305 or from a direct user interface 2325 over a secure communication network 2310 to a regulatory compliance assessment system 2320 for review. For the first pass, only data necessary to provide a worst-case result is sent for review. The data files or loan files that are found to be in compliance with the worst-case input data are ensured to be in compliance when submitted with less than worst-case data. Data files that are not in compliance with worst-case data, either because they are received as false positives in the first pass or because they are truly not in compliance, must be populated with a complete set of actual data to determine compliance.

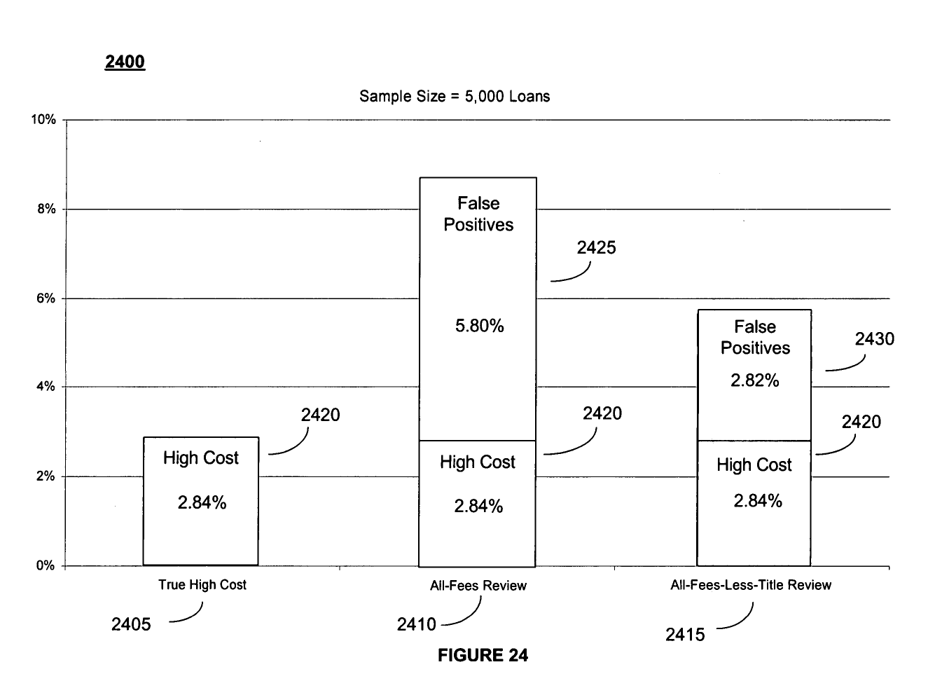

Turning to FIG. 24, FIG. 24 depicts actual results from subjecting a sample of 5,000 mortgage loan files to the one pass/two pass methodology for determining which of the 5,000 mortgage loan files actually represent high cost mortgage loans, according to regulatory compliance requirements. By first performing a detailed high cost compliance review 2405 of each of the 5,000 mortgage loan files using complete sets of fee data, it was determined that 2.84% of the mortgage loan data files were truly high cost mortgage loans 2420. An all-fees first pass review 2410 was then conducted on the 5,000 mortgage loan files using all fees, including those that make a contribution to high cost and those that do not make a contribution to high cost. This all-fees first pass review resulted in finding that 2.84% of truly high cost loans 2420 were not in compliance as well as 5.80% of the loans that were not truly high cost, but resulted in false positive reviews 2425 for high cost loan noncompliance. Another all-fees-less-title first pass review was conducted on the 5,000 mortgage loan files using all fees less those fees related to title. This all-fees-less-title first pass review resulted in finding that 2.84% of truly high cost loans 2420 were not in compliance as well as 2.82% of the loans that were not truly high cost, but resulted in false positive reviews 2430 for high cost loan noncompliance. The benefits of this two-pass methodology is minimization of workflow interruption, a quicker review cycle, ability to review loans with incomplete data and allocation of costs to a minimum number of high cost or nearly high cost loan data files.

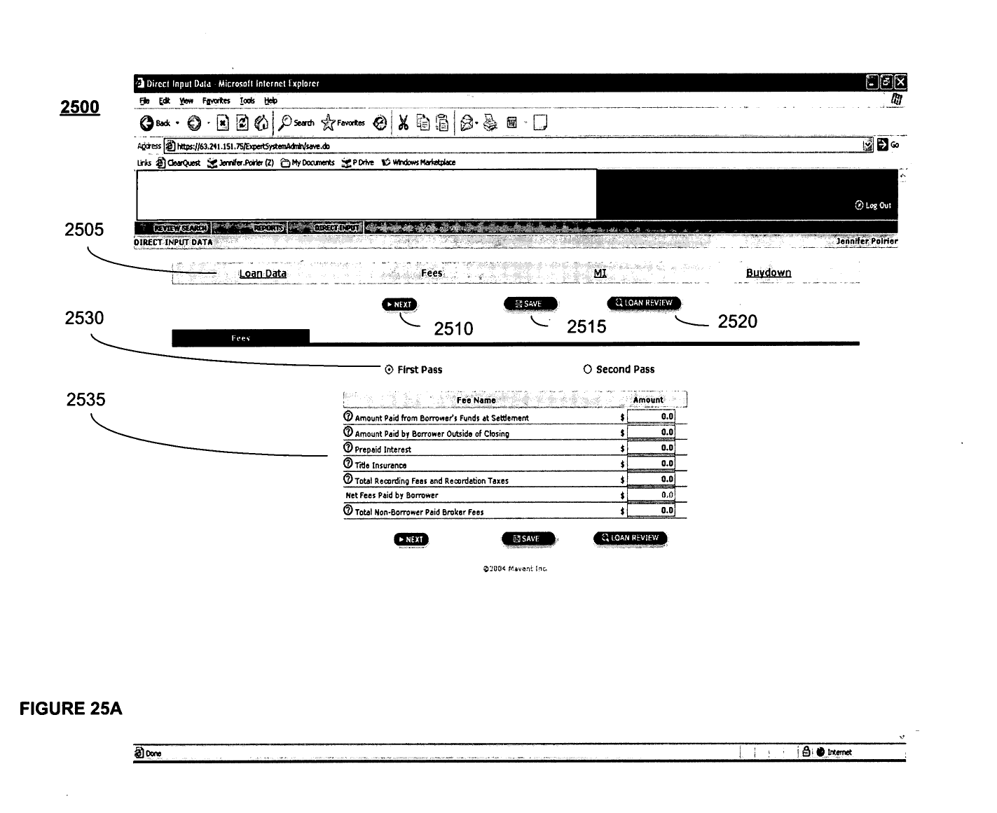

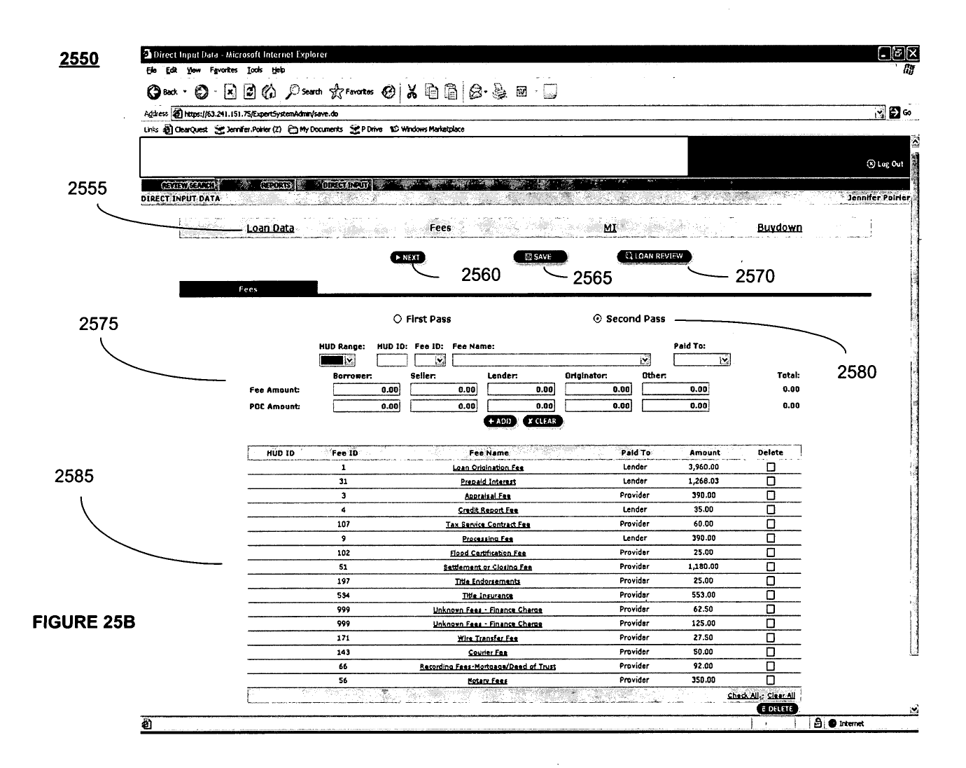

Turning to FIG. 25A, FIG. 25A shows a direct user interface screenshot 2500 depicting a data entry menu for a first pass of the one pass/two pass methodology. FIG. 25B shows a direct user interface screenshot 2550 depicting a data entry menu for a second pass of the one pass/two pass methodology. The general navigation elements of FIG. 25A and FIG. 25B include a loan data selection 2505, 2555 that enables a first pass selection 2530 or a second pass selection 2580. A next selection 2510, 2560 enables selection of the next loan file and a save selection 2515, 2565 enables the current loan data to be saved. The loan review button 2520, 2570 enables the displayed data elements to be entered into a loan data file and submitted for review by the associated regulatory compliance assessment system, and the results are returned to the direct user input interface. One of two fee entry approaches are available, a first pass gross fee entry 2535 shown in the first pass screenshot 2500 and a second pass detail fee entry 2585 shown in the second pass screenshot 2585. Also illustrated in the second pass screenshot is a menu 2575 for entering selected HUD data and fee data allocated between buyer, seller, lender, originator and other. The user may alternate between the two approaches by selecting one of the two fee entry approach buttons 2530, 2580. The screen 2550 is used to enter detailed fees when there is no fee map available. Without a fee map, the implication is that the default fees will be utilized and that the user has selected to do a “Second Pass” review 2548.

The following is a typical sequence of events:
1) The user decides to enter fees based on either working with HUD ranges or by entering default ID's directly.
2) If the users selects to enter data using the HUD Range approach, then:
   a. User enters the HUD ID in the top line. Based on the value, the appropriate HUD Range is pre-selected.
   b. The value set in the HUD Range limits the values in the default fee name dropdown list to only those values that are mapped to the selected HUD Range.
   c. The user enters the Amount, Paid By, and Paid To values.
   d. Tabbing off of the last field drops to the Add Fee button. When the button is pressed, the new data is added to the grid below and the cursor is returned to the HUD ID field and the HUD ID value is set back to blank, as is the related HUD Range and default Fee Name fields.
   e. The user then enters the subsequent fees in succession, using steps (a) to (d).
3) If the users selects to enter data using the default fees approach, then:
   a. User optionally enters the HUD ID in the top line.
   b. User enters the Mavent Fee ID. This automatically populates the default Fee Name field.
   c. The user enters the Amount, Paid By, and Paid To values.
   d. Tabbing off of the last field drops to the Add Fee button. When the button is pressed, the new data is added to the grid below and the cursor is returned to the HUD ID field and the HUD ID value is set back to blank, as is the related HUD Range and default Fee Name fields.
   e. The user then enters the subsequent fees in succession, using steps (a) to (d).

The direct user interface provides the capability to utilize first pass/second pass functionality. First pass functionality provides the option to input a limited set of data rather than all fee detail, which is required for a second pass review. The benefit of first pass to users of the regulatory compliance assessment system is that with limited input data, most or all of which is available electronically, the universe of potential high cost loans can be reduced significantly. Once the smaller group potential high cost loans has been identified via first pass, users can input detailed fee information for a second pass review to determine more accurately if a loan is indeed high cost. The first pass/second pass method significantly limits the amount of effort required to attain a high level of accuracy in identifying high cost loans.

Users will be able to toggle back and forth from a first pass to a second pass screen by selecting one of two radio buttons 2530, 2580 that will be displayed near the top of both screens. The first pass input screen will require dollar amounts to be input into at least one and up to six fee entries described in more detail below. This input will be used to write fee data to the regulatory compliance assessment system. The second pass input screen will use a complete set of current fee data. When the second pass method is being used, fee data will be submitted to the direct user interface as described above in relation to FIG. 25B.

In order to properly handle first pass/second pass functionality, a data element that relates to which fee input method is being used is required to indicate which fee entry approach has been selected. Based on the radio button selected, a particular screen associated with the input method desired will be displayed. Also, based on the radio button selected, a different set of inputs will be stored and a different set of fee data will be submitted to the regulatory compliance assessment system.

If the first pass radio button is selected 2530, a first pass fee screen 2500 will be displayed that will handle the input of six monetary amounts and display a seventh calculated field entitled “Net Fees Paid by Borrower”. The seven amounts 2535 will be:
Amount Paid from Borrower's Funds at Settlement
Amount Paid by Borrower Outside of Closing
Prepaid Interest
Title Insurance Premiums
Total Recording Fees and Recordation Taxes
Net Fees Paid by Borrower
Total Non-Borrower Paid Broker Fees

Input data is required for “Amount Paid from Borrower's Funds at Settlement”, “Amount Paid by Borrower Outside Closing”, and “Total Non-Borrower Paid Broker Fees”. “Title Insurance”, “Total Recording Fees and Recordation Taxes”, and “Prepaid Interest” are optional and defaults to amounts of zero if no input is provided. “Net Fees Paid by Borrower” is a calculated field that will equal “Amount Paid from Borrower's Funds at Settlement”+“Amount Paid by Borrower Outside of Closing”—“Prepaid Interest”—“Title Insurance”—“Total Recording Fees and Recordation Taxes”.

First pass data is handled separately from second pass data in a single input session. This should allow users to toggle back and forth to see the different inputs and to have either set of data submitted to the regulatory compliance assessment system. The data stored for first pass is in the same format as it is stored for second pass. With first pass data, the fee ID's and associated values will always be the same, only the amounts will change from loan to loan;

The following definitions are provided as help text associated with each of the input amounts on the first pass screen:

Amount Paid from Borrower's Funds at Settlement: Enter the total of all fees paid from the borrower's funds at closing/settlement. Typically, this total can be found on line 1400 (Total Settlement Charges) in the Paid from Borrower's Funds at Settlement column on the HUD-1 or HUD-1A. This amount will be included in all high cost calculations.

Amount Paid by Borrower Outside of Closing: Enter the total of all fees paid outside of closing by the Borrower. These are amounts paid by the borrower prior to closing/settlement. Typically, these fees are found itemized on the HUD-1 or HUD-1A to the left of the borrower's column, with the designation POCB or POC-Borrower. This amount will be included in all high cost calculations.

Prepaid Interest: Enter the total amount of prepaid interest (also known as interim interest or odd-days interest) paid by the Borrower at closing/settlement. Typically, this amount can be found on line 901 in the Paid from Borrower's Funds at Settlement column on the HUD-1 or HUD-1A. This amount will be deducted from the total possible points and fees amount when performing a points and fees calculation.

Title Insurance: Enter the total amount of title insurance paid by the Borrower at or before closing/settlement to a third party not affiliated with the Lender or Broker. DO NOT INCLUDE any title insurance paid to the Lender, Broker, or an Affiliate of either. The title insurance total should include amounts for Lender's Coverage (HUD Line 1109) and Owner's Coverage (HUD Line 1110) and Title Endorsements. DO NOT INCLUDE other title charges such as settlement and closing fees, document preparation fees, notary fees, attorney's fees, or other miscellaneous title charges. The total Title Insurance amount will be deducted from the total possible points and fees amount when performing a points and fees calculation.

Total Recording Fees and Recordation Taxes: Enter the total amount for Recording Fees for the Mortgage, Deed of Trust, or Release documents (HUD Line 1201) plus any Recordation Tax amounts (such as documentary tax stamps or intangibles tax—HUD Lines 1202 and 1203) paid by the Borrower to a public official. In most jurisdictions, this amount will be deducted from the total possible points and fees amount when performing a points and fees calculation.

Total Non-Borrower Paid Broker Fees: Enter the total amount of all compensation to the Mortgage Broker paid by someone other than the Borrower. This includes, for example, Yield Spread Premiums, Servicing Release Premiums, and other Lender Paid Broker Fees paid by the Lender to the Broker. This amount will be included in the points and fees calculation in all jurisdictions in which such broker compensation is included in the definition of points and fees.

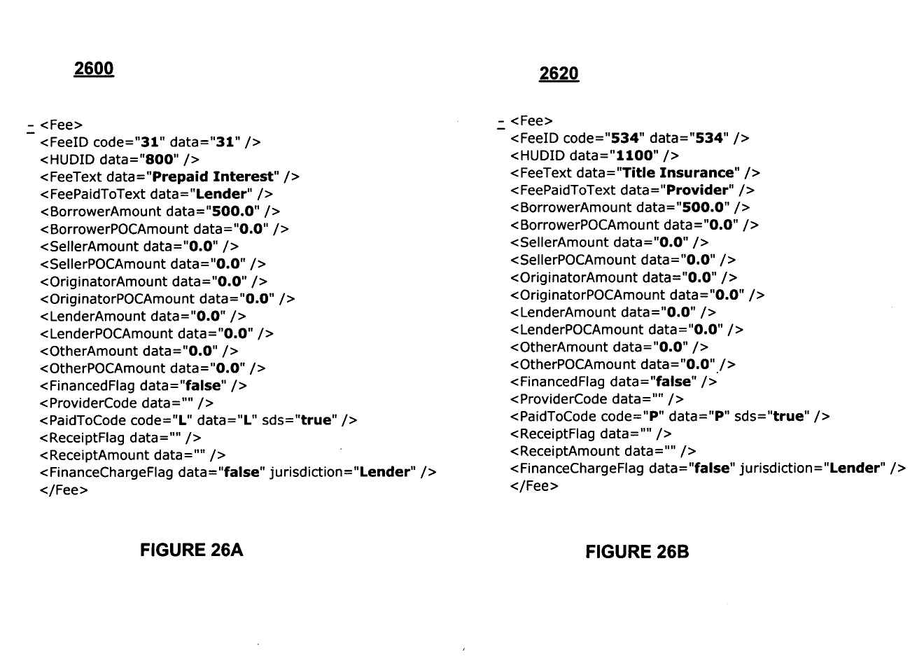

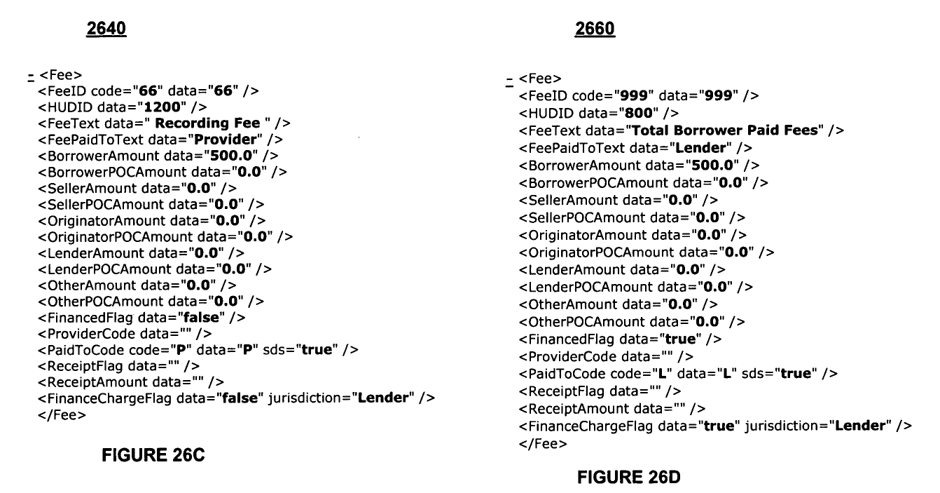

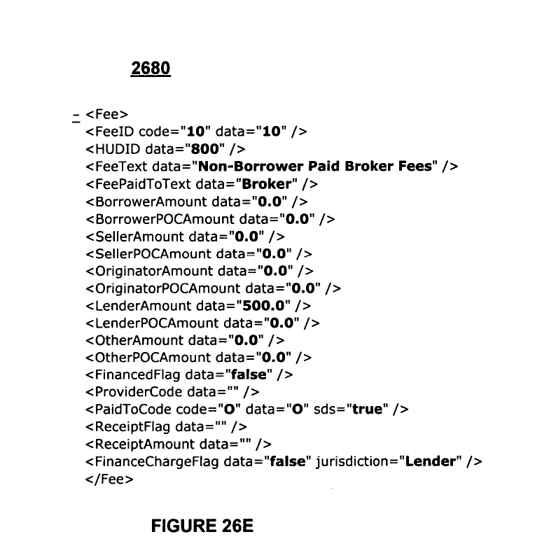

Turning to FIG. 26, FIGS. 26A-26E show examples of XML files representing data submitted to the regulatory compliance assessment system for review of prepaid interest 2600, title insurance premiums 2620, recording fees 2640, total amount paid by borrower 2660, and total non-borrower paid broker fees 2680. The input amounts for these fees will be submitted to the regulatory compliance assessment system in the fee data format provided as shown in FIGS. 26A-26E. Each of the input amounts for first pass is associated with a specific fee number and associated fee data values. The direct user interface will assemble fee data in the same format as second pass fees and submit it to regulatory compliance assessment system for review. The direct user interface will insert the amounts from the five fields listed above into the “templates” shown. In FIGS. 26A-26E, an arbitrary amount of $500 was entered in to the XML templates.

Although the present invention has been described in detail with reference to certain preferred embodiments, it should be apparent that modifications and adaptations to those embodiments might occur to persons skilled in the art without departing from the spirit and scope of the present invention.

What is claimed is:

1. A two-pass method for regulatory compliance assessment, comprising the steps of:
populating one or more financial transaction data files with selected limited sets of data to produce a worst-case result when subjecting the transaction data files with limited data sets to compliance assessment with one or more computer-encoded compliance rule sets;
using a first pass, assessing compliance of the one or more financial transaction data files having the limited sets of data with the one or more compliance rule sets using a computer-implemented regulatory compliance assessment system resulting in first pass compliant data files and first pass noncompliant data files;
populating the first pass noncompliant financial transaction data files with detailed sets of data;
using a second pass, assessing compliance of the first pass noncompliant financial transaction data files having the detailed sets of data with the one or more compliance rule sets using the computer-implemented regulatory compliance assessment system resulting in second pass compliant data files and second pass noncompliant data files; and
classifying the first pass and second pass compliant data files as being in compliance and the second pass noncompliant data files as not being in compliance with the one or more compliance rule sets by the regulatory compliance assessment system.

2. The method of claim 1, wherein the step of populating one or more financial transaction data files with selected limited sets of data comprises populating one or more financial transaction data files with selected limited sets of data for determining with a high cost mortgage loan compliance rule set, comprising:
selecting an amount paid from borrower's funds at settlement;
selecting an amount paid by borrower outside of closing;
selecting prepaid interest;
selecting total title insurance premiums;
selecting total mortgage recording fees and recordation taxes; and
selecting total non-borrower paid broker fees.

3. The method of claim 1, wherein the step of populating one or more financial data files using the limited sets of data comprises:
performing a loan lookup and search using a direct user interface;
entering and editing a selected set of limited data into one or more financial transaction data files; and
validating the limited set of data prior to the first pass.

4. The method of claim 3, wherein the step of entering and editing comprises entering and editing limited sets of data for determining potential high cost mortgage loans including an amount paid from borrower's funds at settlement, an amount paid by borrower outside of closing, prepaid interest, total title insurance premiums, total mortgage recording fees and recordation taxes, and total non-borrower paid broker fees.

5. The method of claim 1, wherein the steps of assessing compliance of the one or more financial transaction data files comprises the steps of:
creating the one or more computer-encoded compliance rule sets derived from laws and regulations;
storing the one or more computer-encoded compliance rule sets in a regulatory compliance rules repository;
assessing regulatory compliance of the one or more financial transaction data files by comparing the one or more financial transaction data files with the one or more computer-encoded compliance rule sets in the regulatory compliance rules repository; and
producing a regulatory compliance assessment result for indicating compliance and non-compliance of the one or more transaction data files with the one or more computer-encoded compliance rule sets.

6. The method of claim 1, wherein the step of populating the first pass noncompliant financial transaction data files with detailed sets of data comprises:
selectively loading a selected set of detailed data by batch loading flat files and spreadsheet files into the one or more financial transaction data files;
performing a loan lookup and search using a direct user interface;
manually entering and editing a selected set of detailed data into the one or more financial transaction data files; and
validating the detailed set of data prior to the second pass.

7. The method of claim 6, wherein the step of manually entering and editing, and selectively loading comprises entering and editing and selectively loading detailed sets of data for determining high cost mortgage loans including payer and payee of each fee charged at closing/settlement and outside closing/settlement.

8. The method of claim 7, wherein the one or more noncompliant financial data files is designated as a high cost mortgage loan.

9. The method of claim 1, wherein a compliance rule set is selected from the group consisting of theory of lending, Home Ownership and Equity Protection Act, State and Local High Cost, Truth in Lending, Predatory Lending, Real Estate Settlement Procedures Act, Sate and Local Consumer Credit Laws, Lender and Broker Licensing, Home Mortgage Disclosure Act, Office of Foreign Asset Control requirements, Flood Zone Validation, Enterprise Rules, and Customer Position Rules.

10. The method of claim 1, wherein the one or more financial data files comprises a data file group that is created, modified, populated with sets of data, assessed and classified as compliant and noncompliant as a group.

11. The method of claim 1, further comprising viewing and printing the noncompliant and noncompliant financial transaction data files.

12. The method of claim 1, wherein the limited data sets are selected from a default limited data template.

13. The method of claim 1, wherein the detailed data sets are selected from a default detailed data template.

14. A two-pass system for regulatory compliance assessment, comprising:
means for populating one or more financial transaction data files with selected limited sets of data to produce a worst-case result when subjecting the transaction data files with limited data sets to compliance assessment with one or more computer-encoded compliance rule sets;
a first pass means for assessing compliance of the one or more financial transaction data files having the limited sets of data with the one or more compliance rule sets using a computer-implemented regulatory compliance assessment system resulting in first pass compliant data files and first pass noncompliant data files;
means for populating the first pass noncompliant financial transaction data files with detailed sets of data;
a second pass means for assessing compliance of the first pass noncompliant financial transaction data files having the detailed sets of data with the one or more compliance rule sets using the computer-implemented regulatory compliance assessment system resulting in second pass compliant data files and second pass noncompliant data files; and
means for classifying the first pass and second pass compliant data files as being in compliance and the second pass noncompliant data files as not being in compliance with the one or more compliance rule sets by the regulatory compliance assessment system.

15. The system of claim 14, wherein the means for populating one or more financial transaction data files with selected limited sets of data is a direct user interface.

16. The system of claim 15, wherein the direct user interface is a browser-based user interface communicating with the regulatory compliance assessment system over a secure communication channel.

17. The system of claim 14, wherein the means for populating the first pass noncompliant financial transaction data files with detailed sets of data is a direct browser-based user interface and a batch file load interface.

18. The system of claim 17, wherein the direct user interface is a web browser based interface communicating with the regulatory compliance assessment system over a secure communication channel and the batch file load interface communicates with the regulatory compliance assessment system over a secure communication channel for batch loading flat files and spreadsheet files into the one or more selected financial transaction data files.

19. The system of claim 14, wherein the limited data sets are selected from a default limited data template.

20. The system of claim 14, wherein the detailed data sets are selected from a default detailed data template.

21. A two-pass method for regulatory compliance assessment, comprising the steps of:
populating one or more financial transaction data files with limited data sets for producing a worst case compliance assessment result;
performing a first pass compliance assessment of the one or more financial transaction data files with limited data sets resulting in first pass compliant data files and first pass noncompliant data files;
populating the first pass noncompliant financial transaction data files with detailed data sets;
performing a second pass compliance assessment of the first pass noncompliant data files with detailed data sets resulting in second pass compliant data files and second pass noncompliant data files; and
classifying the first pass compliant data files and the second class compliant data files as being compliant with regulatory requirements, and classifying the second pass noncompliant data files as being noncompliant with regulatory requirements.

22. The method of claim 21, wherein the limited data sets are selected from a default limited data template.

23. The method of claim 21, wherein the detailed data sets are selected from a default detailed data template.

24. The method of claim 21, wherein the steps of performing compliance assessment of the financial transaction data files comprises the steps of:
storing the one or more computer-encoded compliance rule sets in a regulatory compliance rules repository;
comparing the financial transaction data files with the one or more computer-encoded compliance rule sets in the regulatory compliance rules repository; and
producing a regulatory compliance assessment result for indicating compliance and non-compliance of the transaction data files with the one or more computer-encoded compliance rule sets.
